(19) United States
(12) Patent Application Publication
(10) Pub. No.: US 2026/0300209 A1
(43) Pub. Date: Oct. 1, 2026

(54) COMMUNICATION BETWEEN TARGET-SIDE DATA INTERFACE DEVICE AND HOST-SIDE DATA INTERFACE DEVICE

(71) Applicant: QUALCOMM Incorporated, San Diego, CA (US)

(72) Inventors: Parth Saurabhkumar SHAH, Bangalore (IN); Sanjukta DAS, Visakhapatnam (IN); Mohit Kishore PRASAD, San Diego, CA (US)

(21) Appl. No.: 19/091,152

(22) Filed: Mar. 26, 2025

(51) Int. Cl. G06F 13/42

(52) U.S. Cl. CPC G06F 13/4221; G06F 2213/4004

(57) ABSTRACT

A target-side data interface device includes upstream ports, device controllers, and data end points (EPs). Each of the upstream ports is assigned to a respective group of data EPs and is configured to send communications associated with the respective group of data EPs via a respective communication link to a host-side data interface device. Each of the device controllers is configured to be coupled to at least one respective device. Each of the data EPs is coupled to a respective device controller. The data EPs include a first data EP coupled to a first device controller. The first data EP is configured to send, to a first upstream port that is assigned to the first data EP, a first input/output (I/O) status message corresponding to an interrupt indicating a first I/O status of a first I/O operation of a first device coupled to the first device controller.

### I. FIELD

The present disclosure is generally related to communication between a target-side data interface device and a host-side data interface device.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate peripheral devices, such as a camera, a gyroscope, an accelerometer, etc. Foldable devices, such as flip phones, are increasingly being manufactured to include more peripheral devices. To illustrate, peripheral devices are often included on a target-side of a foldable device that is connected via flex cables to a host-side of the foldable device that includes a system-on-chip (SOC). Having a separate communication link (e.g., a separate wire) between each peripheral device and the host-side can increase the bulkiness of the flex cables and hence the foldable device.

### III. SUMMARY

According to one implementation of the present disclosure, a target-side data interface device includes a plurality of upstream ports, each of the plurality of upstream ports assigned to a respective group of data end points (EPs) of a plurality of data EPs and each of the plurality of upstream ports configured to send communications associated with the respective group of data EPs via a respective communication link to a host-side data interface device. The target-side data interface device also includes a plurality of device controllers, each of the plurality of device controllers configured to be coupled to at least one respective device. The target-side data interface device further includes the plurality of data EPs, each of the plurality of data EPs coupled to a respective device controller of the plurality of device controllers. The plurality of data EPs includes a first data EP coupled to a first device controller of the plurality of device controllers. The first data EP is configured to send, to a first upstream port of the plurality of upstream ports that is assigned to the first data EP, a first input/output (I/O) status message corresponding to an interrupt indicating a first I/O status of a first I/O operation of a first device coupled to the first device controller.

According to another implementation of the present disclosure, a host-side data interface device includes a plurality of downstream ports, each of the plurality of downstream ports assigned to a respective group of data end points (EPs) of a plurality of data EPs, and each of the plurality of downstream ports configured to send communications to the respective group of data EPs via a respective communication link to a target-side data interface device. The host-side data interface device also includes a plurality of link controllers, each of the plurality of link controllers coupled to a respective downstream port of the plurality of downstream ports. The host-side data interface device further includes a plurality of interface controllers, each of the plurality of interface controllers coupled to a respective link controller of the plurality of link controllers. A first interface controller of the plurality of interface controllers is configured to receive a notification of an input/output (I/O) message associated with a data channel, the I/O message addressed to a first device. The first interface controller is also configured to, based on a determination that the first device is coupled to a first data EP of the plurality of data EPs and that the first data EP is assigned to a first downstream port of the plurality of downstream ports, send an I/O request via a first link controller to the first downstream port.

According to another implementation of the present disclosure, a host-side data interface device includes a downstream port configured to be coupled via a communication link to a target-side data interface device. The host-side data interface device also includes an interrupt controller coupled to the downstream port and to an interface controller. The interrupt controller is configured to receive an interrupt message from the downstream port, the interrupt message indicating an interrupt end point (EP) identifier of an interrupt EP and an input/output (I/O) status, the I/O status corresponding to an interrupt associated with an I/O operation of a first device. The interrupt controller is also configured to, based on a determination that the interrupt message includes the interrupt EP identifier, provide the I/O status to the interface controller.

According to another implementation of the present disclosure, a method includes receiving, at a data end point (EP) of a plurality of data end points of a target-side data interface device, an interrupt from a device controller of a plurality of device controllers of the target-side data interface device, the interrupt indicating an I/O status of an I/O operation of a first device coupled to the device controller. The method also includes sending, from the data ep to an upstream port of a plurality of upstream ports that is assigned to the data ep, an i/o status message corresponding to the interrupt, where each of the plurality of upstream ports of the target-side data interface device is assigned to a respective group of data end points of the plurality of data points, and where each of the plurality of upstream ports is configured to send communications associated with the respective group of data end points via a respective communication link to a host-side data interface device.

According to another implementation of the present disclosure, a method includes receiving, at an interface controller of a host-side data interface (HSDI) device, a notification of an I/O message of a data channel, the I/O message addressed to a first device. The method also includes, based on determining that the first device is coupled to a data end point (EP) of a plurality of data end points of a target-side data interface device, sending an I/O request from the interface controller via a link controller to a downstream port of a plurality of downstream ports that is assigned to the data EP, where each of the plurality of downstream ports is assigned to a respective group of data end points of the plurality of data end points, and where each of the plurality of downstream ports is configured to send communications to the respective group of data end points via a respective communication link to the target-side data interface device.

According to another implementation of the present disclosure, a method includes receiving, at an interrupt controller of a host-side data interface device, an interrupt message from a downstream port. The interrupt message indicates an interrupt end point (EP) identifier of an interrupt EP of a target-side data interface device. The interrupt message also indicates an input/output (I/O) status corresponding to an interrupt associated with an I/O operation of a first device. The method also includes, based on a determination that the interrupt message includes the interrupt EP identifier, providing the I/O status to an interface controller of the host-side data interface device.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to enable communication between a target-side data interface device and a host-side data interface device, in accordance with some examples of the present disclosure.

FIG. 2 is a block diagram of another illustrative example of a system operable to enable communication between a target-side data interface device and a host-side data interface device, in accordance with some examples of the present disclosure.

FIG. 3 is a diagram of an illustrative aspect of operations associated with configuration of a system operable to enable communication between a target-side data interface device and a host-side data interface device, in accordance with some examples of the present disclosure.

FIG. 4 is an example of message formats of messages exchanged during the configuration described with reference to FIG. 3, in accordance with some examples of the present disclosure.

FIG. 5 is a diagram of an illustrative aspect of operations at a host-side data interface device that are associated with a host-initiated write, in accordance with some examples of the present disclosure.

FIG. 6A is a diagram of an illustrative aspect of operations at a target-side data interface device that are associated with the host-initiated write, in accordance with some examples of the present disclosure.

FIG. 6B is a diagram of an illustrative aspect of operations at the target-side data interface device that are associated with the host-initiated write, in accordance with some examples of the present disclosure.

FIG. 7 is a diagram of an illustrative aspect of operations at the host-side data interface device that are associated with the host-initiated write, in accordance with some examples of the present disclosure.

FIG. 8 is an example of message formats of messages exchanged during the host-initiated write described with reference to FIGS. 5-7, in accordance with some examples of the present disclosure.

FIG. 9 is a diagram of an illustrative aspect of operations at a host-side data interface device that are associated with a host-initiated read, in accordance with some examples of the present disclosure.

FIG. 10A is a diagram of an illustrative aspect of operations at a target-side data interface device that are associated with the host initiated read, in accordance with some examples of the present disclosure.

FIG. 10B is a diagram of an illustrative aspect of operations at the target-side data interface device that are associated with the host-initiated read, in accordance with some examples of the present disclosure.

FIG. 11A is a diagram of an illustrative aspect of operations at the host-side data interface device that are associated with the host-initiated read, in accordance with some examples of the present disclosure.

FIG. 11B is a diagram of an illustrative aspect of operations at the host-side data interface device that are associated with the host-initiated read, in accordance with some examples of the present disclosure.

FIG. 12A is a diagram of an illustrative aspect of operations at the target-side data interface device that are associated with the host-initiated read, in accordance with some examples of the present disclosure.

FIG. 12B is a diagram of an illustrative aspect of operations at the target-side data interface device that are associated with the host-initiated read, in accordance with some examples of the present disclosure.

FIG. 13 is a diagram of an illustrative aspect of operations at the host-side data interface device that are associated with the host-initiated read, in accordance with some examples of the present disclosure.

FIG. 14 is an example of message formats of messages exchanged during the host-initiated read described with reference to FIGS. 9-13, in accordance with some examples of the present disclosure.

FIG. 15 is a diagram of an illustrative aspect of operations at a target-side data interface device that are associated with a device-initiated read, in accordance with some examples of the present disclosure.

FIG. 16 is a diagram of an illustrative aspect of operations at a host-side data interface device that are associated with the host-initiated read, in accordance with some examples of the present disclosure.

FIG. 17 is a diagram of a header format of an inter-integrated circuit (I2C) input/output (I/O) request, in accordance with some examples of the present disclosure.

FIG. 18 is a diagram of a header format of an improved inter-integrated circuit (I3C) I/O request, in accordance with some examples of the present disclosure.

FIG. 19 is a diagram of a header format of a serial peripheral interface (SPI) I/O request, in accordance with some examples of the present disclosure.

FIG. 20 is a diagram of a header format of a universal asynchronous receiver/transmitter (UART) I/O request, in accordance with some examples of the present disclosure.

FIG. 21 is a diagram of an example of a mobile device operable to enable communication between a target-side data interface device and a host-side data interface device, in accordance with some examples of the present disclosure.

FIG. 22 is a diagram of another example of a mobile device operable to enable communication between a target-side data interface device and a host-side data interface device, in accordance with some examples of the present disclosure.

FIG. 23 is a diagram of a particular implementation of a method of communication between a target-side data interface device and a host-side data interface device that may be performed at the target-side data interface device, in accordance with some examples of the present disclosure.

FIG. 24 is a diagram of a particular implementation of a method of communication between a target-side data interface device and a host-side data interface device that may be performed at the host-side data interface device, in accordance with some examples of the present disclosure.

FIG. 25 is a diagram of a particular implementation of a method of communication between a target-side data interface device and a host-side data interface device that may be performed at the host-side data interface device, in accordance with some examples of the present disclosure.

FIG. 26 is a block diagram of a particular illustrative example of a device that is operable to enable communication between a target-side data interface device and a host-side data interface device, in accordance with some examples of the present disclosure.

### V. DETAILED DESCRIPTION

Foldable devices, such as flip phones, are increasingly being manufactured to include more peripheral devices. To illustrate, peripheral devices are often included on a target-side of a foldable device that is connected via flex cables to a host-side of the foldable device that includes a system-on-chip (SOC). Having a separate communication link (e.g., a separate wire) between each peripheral device on the target-side of the foldable device and the SOC on the host-side can increase the bulkiness of the flex cables and hence the foldable device.

Systems and methods that enable communication between a target-side data interface device and a host-side data interface device of a system (e.g., a foldable electronic device) are disclosed. In an example, the host-device data interface device includes an SOC that supports one or more execution environments, and each execution environment can support one or more respective applications.

The target-side data interface device includes a plurality of data end points (EPs) and a plurality of device controllers. Each data EP is coupled to a respective device controller of the plurality of device controllers, and each of the plurality of device controllers is configured to be coupled to at least one respective device (e.g., one or more peripheral devices). The host-side data interface device includes one or more downstream ports, and the target-side data interface device includes one or more upstream ports. Each downstream port of the host-side data interface device is configured to be coupled via a respective communication link to a respective upstream port of the target-side data interface device.

In examples in which there are multiple communication links between the host-side data interface device and the target-side data interface device, a pair of ports (e.g., a downstream port and an upstream port) associated with a communication link is assigned to a group of data EPs. For example, a first downstream port and a first upstream port that are coupled to each other via a first communication link are assigned to a first group of data EPs. As another example, a second downstream port and a second upstream port that are coupled to each other via a second communication link are assigned to a second group of data EPs. Communications between the host-side data interface device and devices corresponding to the first group of data EPs can be sent via (e.g., aggregated through) the first communication link, and communications between the host-side data interface device and devices corresponding to the second group of data EPs can be sent via (e.g., aggregated through) the second communication link.

Optionally, in some examples, the first communication link has a greater data transfer speed than the second communication link, the first group of data EPs corresponds to high power devices, and the second group of data EPs corresponds to low power devices. As referred to herein, a “high power” device communicates with the SOC when the SOC is in a high power (e.g., awake) mode and not when the SOC is in a low power (e.g., sleep) mode, and a “low power” device can communicate with the SOC when the SOC is in the low power mode, when the SOC is in the high power mode, or both.

A technical advantage of aggregating communications of a group of devices into a corresponding communication link includes reducing the number of communication links between the host-side data interface device and the target-side data interface device, as compared to a dedicated communication link per device to the host-side data interface device. In some examples, reducing the number of communication links between the host-side data interface device and the target-side data interface device can result in less bulky flex cables between the host-side data interface device and the target-side data interface device, and a sleeker foldable device. Fewer communication links can also reduce cost and complexity associated with manufacturing the foldable device.

In some examples, input/output (I/O) requests generated by the host-side data interface device addressed to different data EPs have a format that includes headers of a pre-determined size (e.g., a same size) although the different data EPs may communicate using different communication protocols. Because each header has the same pre-determined size, data in a write request may be located in a pre-determined portion of the write request regardless of which data EP is to receive the write request. An upstream port of the target-side data interface device can copy the data from the pre-determined portion of the write request to a receive buffer coupled to the data EP without having to parse the header. A technical advantage of such fixed size headers includes enabling write requests to data EPs, that may communicate using different communication protocols, to be aggregated via the same communication link to an upstream port with little or no added processing or latency at the upstream port.

In some examples, the host-side data interface device includes an interrupt controller coupled to an interface controller. A downstream port of the target-side data interface device sends, to the host-side data interface device, an interrupt message indicating an I/O status of an I/O operation at a device (e.g., a peripheral device) that is associated with a data EP. The interrupt message includes a value (e.g., an identifier of an interrupt controller EP) that causes the interrupt controller to provide the I/O status to the interface controller and not to an application at the SOC. The interface controller, based on determining that the I/O status indicates that a read operation is complete at the device, sends a read command addressed to the data EP via the link controller to initiate transmission of the data from a transmit buffer coupled to the data EP at the target-side data interface device to the host-side data interface device. A technical advantage of having the interface controller send the read command to the data EP includes reducing latency associated with the data read, as compared to an application at the SOC being notified that the read operation is complete at the device and the application initiating a read request at the interface controller.

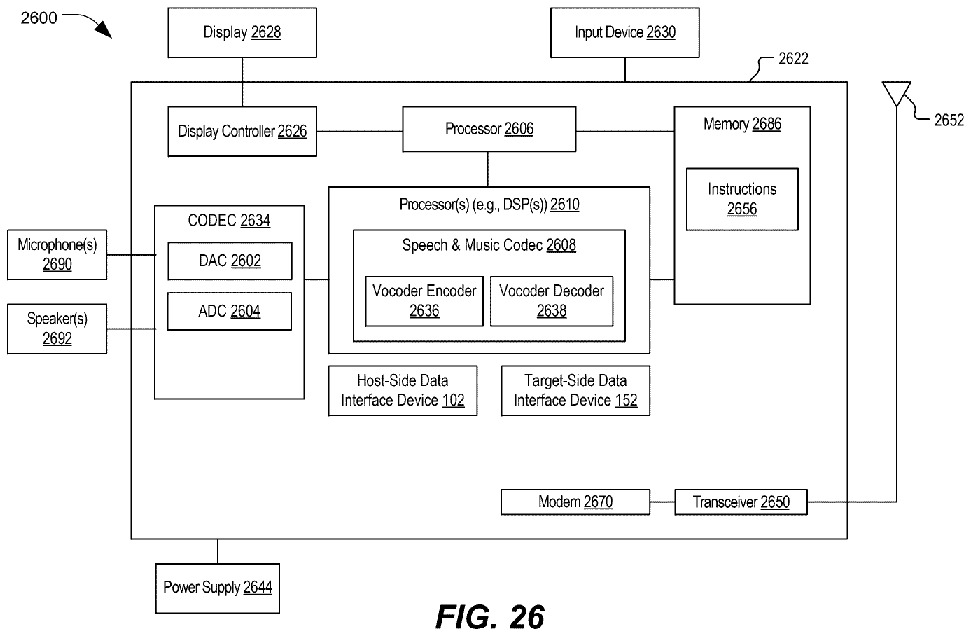

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 26 depicts a device 2600 including one or more processors (“processor(s)” 2610 of FIG. 26), which indicates that in some implementations the device 2600 includes a single processor 2610 and in other implementations the device 2600 includes multiple processors 2610. For ease of reference herein, such features are generally introduced as “one or more” features and are subsequently referred to in the singular or optional plural (as indicated by “(s)”) unless aspects related to multiple of the features are being described.

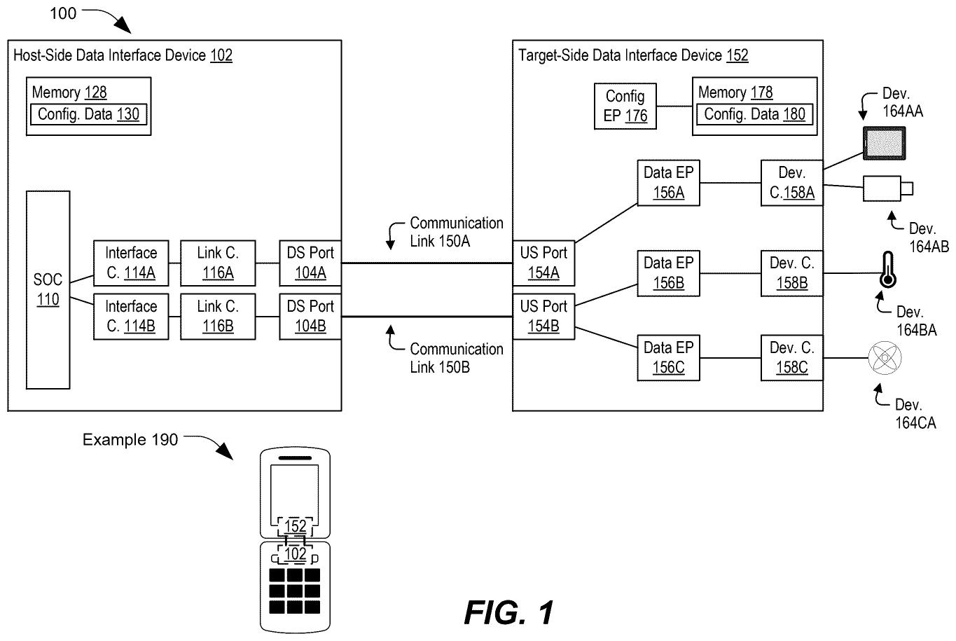

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple downstream ports are illustrated and associated with reference numbers 104A and 104B. When referring to a particular one of these downstream ports, such as a downstream port 104A, the distinguishing letter “A” is used. However, when referring to any arbitrary one of these downstream ports or to these downstream ports as a group, the reference number 104 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

Referring to FIG. 1, a particular illustrative aspect of a system configured to enable communication between a target-side data interface device and a host-side data interface device is disclosed and generally designated 100. The system 100 includes a host-side data interface device 102 that is coupled via a plurality of communication links 150 to a target-side data interface device 152.

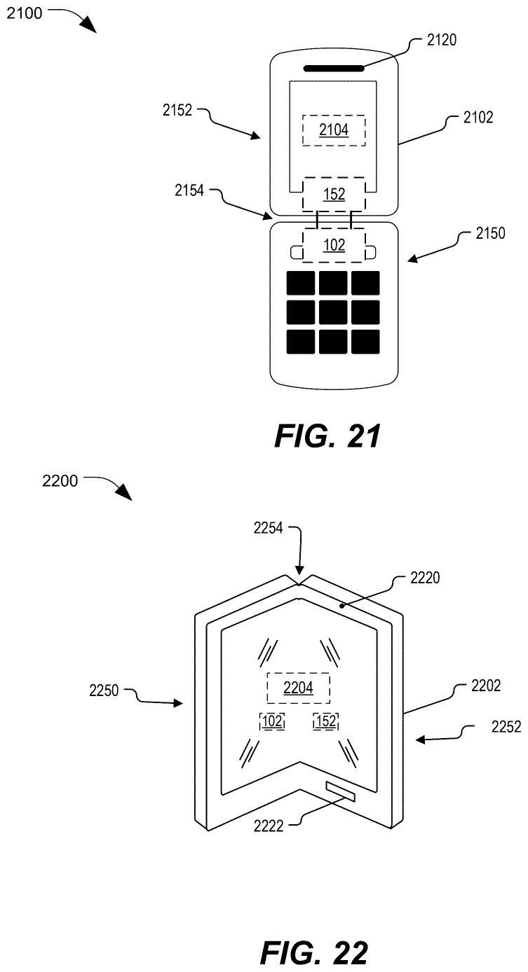

In some examples, the system 100 includes a foldable electronic device, such as a mobile phone, a communication device, a computing device, an entertainment device, or a combination thereof. In an example 190, the system 100 includes a flip phone and a hinge of the flip phone is located between the host-side data interface device 102 and the target-side data interface device 152. In some implementations, the system 100 corresponds to or is included in one of various types of devices. In an illustrative example, the host-side data interface device 102 and the target-side data interface device 152 are integrated in a flip phone, as further described with reference to FIG. 21, or at least one of a foldable phone or foldable tablet, as described with reference to FIG. 22.

The host-side data interface device 102 includes a plurality of downstream (DS) ports 104, such as a DS port 104A, a DS port 104B, one or more additional DS ports, or a combination thereof. Each of the plurality of downstream ports 104 is coupled to a respective communication link 150. For example, the downstream port 104A is coupled to a communication link 150A, and the downstream port 104B is coupled to a communication link 150B.

The host-side data interface device 102 includes a plurality of link controllers 116. Each of the plurality of link controllers 116 is coupled to a respective DS port 104. For example, a link controller 116A (designated as “Link C. 116A” in FIG. 1) is coupled to the DS port 104A. As another example, a link controller 116B (designated as “Link C. 116B” in FIG. 1) is coupled to the DS port 104B. In a particular aspect, the plurality of downstream ports 104 and the plurality of link controllers 116 correspond to hardware components of the host-side data interface device 102.

The host-side data interface device 102 includes a plurality of interface controllers 114. Each of the plurality of interface controllers 114 is coupled to a respective link controller 116. For example, an interface controller 114A (designated as “Interface C. 114A” in FIG. 1) is coupled to the link controller 116A. As another example, an interface controller 114B (designated as “Interface C. 114B” in FIG. 1) is coupled to the link controller 116B. In a particular aspect, the plurality of interface controllers 114 corresponds to firmware components of the host-side data interface device 102.

The host-side data interface device 102 also includes a system-on-chip (SOC) 110 coupled to the plurality of interface controllers 114. In a particular aspect, the SOC 110 is configured to support one or more execution environments, and each execution environment can support one or more respective applications that correspond to software. The host-side data interface device 102 also includes a memory 128 (e.g., one or more registers that define a register space) configured to store configuration data 130.

The target-side data interface device 152 includes a plurality of device controllers 158, such as a device controller 158A (designated as “Dev. C. 158A” in FIG. 1), a device controller 158B (designated as “Dev. C. 158B” in FIG. 1), a device controller 158C (designated as “Dev. C. 158C” in FIG. 1), one or more additional device controllers, or a combination thereof. Each device controller 158 is configured to be coupled to at least one respective device 164 (e.g., a peripheral device). In an example illustrated in FIG. 1, the device controller 158A is coupled to a group of devices 164A, such as a device 164AA (e.g., a touch screen) and a device 164AB (e.g., a camera). In this example, the device controller 158B is coupled to a group of devices 164B, such as a device 164BA (e.g., a temperature sensor), and the device controller 158C is coupled to a group of devices 164C, such as a device 164CA (e.g., a gyroscope). It should be understood that a touch screen, a camera, a temperature sensor, and a gyroscope are provided as illustrative examples of devices 164, in other examples a device controller 158 can be coupled to various other types of devices, such as an accelerometer, a microphone, an I/O device, a speaker, or the like.

The target-side data interface device 152 includes a plurality of data end points (EPs) 156. Each device controller 158 is coupled to a respective data EP 156. For example, the device controller 158A is coupled to a data EP 156A, the device controller 158B is coupled to a data EP 156B, and the device controller 158C is coupled to a data EP 156C.

The target-side data interface device 152 includes a plurality of upstream (US) ports 154, such as an upstream port 154A, an upstream port 154B, one or more additional upstream ports, or a combination thereof. Each of the plurality of upstream ports 154 is coupled to a respective communication link 150. For example, the upstream port 154A is coupled to the communication link 150A, and the upstream port 154B is coupled to the communication link 150B.

The target-side data interface device 152 includes a configuration EP 176 coupled to a memory 178 (e.g., one or more registers that define a register space). The memory 178 is configured to store configuration data 180. In a particular aspect, the configuration data 180 indicates assignments of groups of data EPs 156 to upstream ports 154. For example, the configuration data 180 may indicate, for each of the upstream ports 154, an assignment of the upstream port 154 to a respective group of data EPs 156. In the example illustrated in FIG. 1, the configuration data 180 indicates that the data EP 156A is included in a first data EP group that is assigned to the upstream port 154A coupled to the communication link 150A. In this example, the configuration data 180 indicates that the data EP 156B and the data EP 156C are included in a second data EP group that is assigned to the upstream port 154B coupled to the communication link 150B.

In a particular aspect, the configuration data 180 includes configuration information of the plurality of device controllers 158, such as which data EPs 156, devices 164, or both, are coupled to the device controller 158. In the example shown in FIG. 1, the configuration data 180 indicates that the data EP 156A is coupled via the device controller 158A to the device 164AA and to the device 164AB, that the data EP 156B is coupled via the device controller 158B to the device 164BA, and that the data EP 156C is coupled via the device controller 158C to the device 164CA.

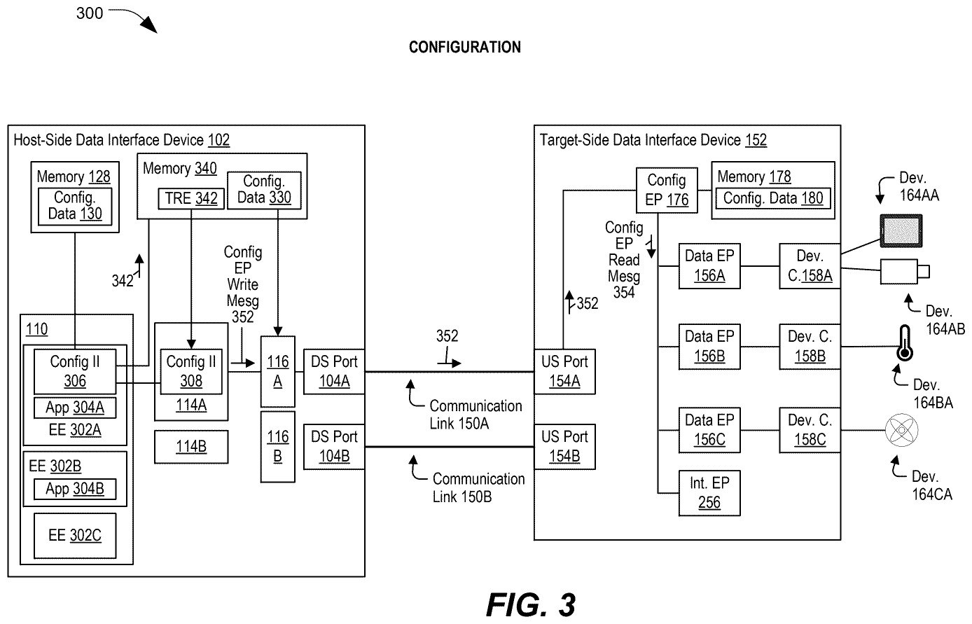

Optionally, in some implementations, the configuration data 180 indicates device registration information of applications of the SOC 110 that are registered to receive notifications regarding interrupts from one or more devices 164. For example, the device registration information indicates that one or more first applications, one or more second applications, one or more third applications, and one or more fourth applications are registered to receive notifications regarding interrupts from the device 164AA, the device 164AB, the device 164BA, and the device 164CA, respectively. A single application can register to receive notifications associated with multiple devices 164. Multiple applications can register to receive notifications from the same device 164. In some aspects, during a configuration phase, the SOC 110 sends a configuration EP write message to the configuration EP 176 to write (e.g., update) the configuration data 180, as further described with reference to FIG. 3.

The configuration data 130 of the host-side data interface device 102 indicates corresponding assignments of the groups of data EPs 156 to the downstream ports 104. For example, the configuration data 130 indicates, for each of the downstream ports 104, an assignment of the downstream port 104 to a respective group of data EPs 156. Each of the downstream ports 104 is configured to send communications to the respective group of data EPs 156 via a respective communication link 150 to the target-side data interface device 152. In the example illustrated in FIG. 1, the configuration data 130 indicates that the data EP 156A is included in the first data EP group that is assigned to the downstream port 104A coupled to the communication link 150A. In this example, the configuration data 130 indicates that the data EP 156B and the data EP 156C are included in the second data EP group that is assigned to the downstream port 104B coupled to the communication link 150B.

In a particular aspect, the configuration data 130 includes the configuration information of the plurality of device controllers 158, the device registration information of applications of the SOC 110, or a combination thereof. In some aspects, the SOC 110 generates (e.g., updates) the configuration data 130 during the configuration phase to indicate the assignments, the configuration information of the plurality of device controllers 158, the device registration information of applications, or a combination thereof, as further described with reference to FIG. 3.

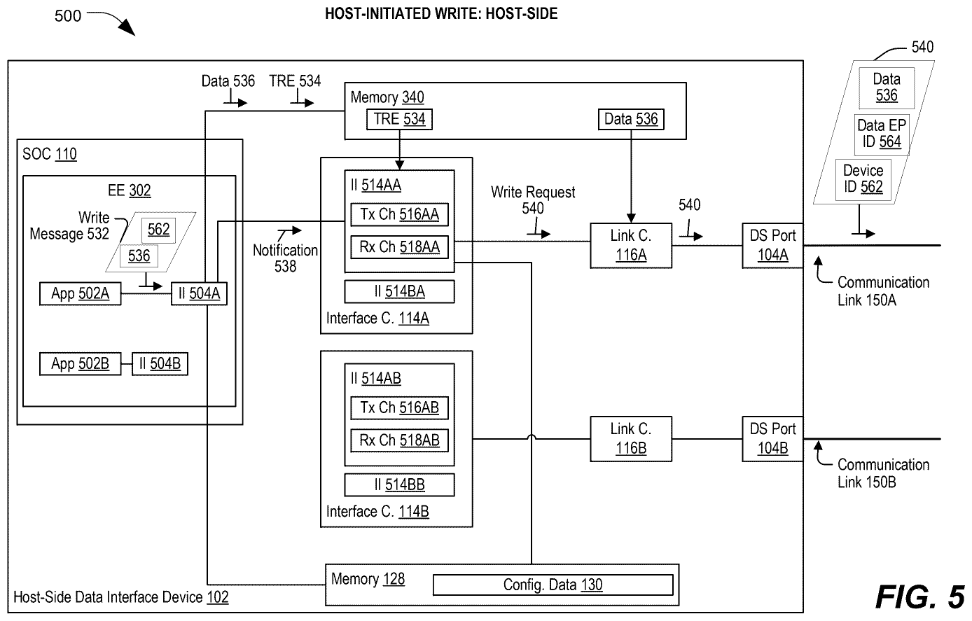

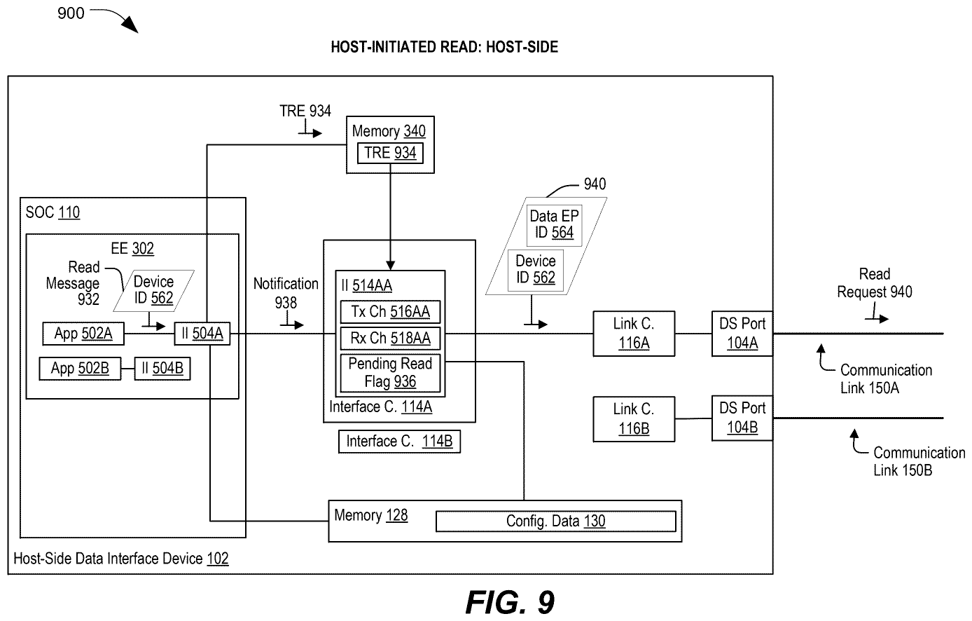

During operation of the system 100, the interface controllers 114 maintain data channels associated with applications of the SOC 110 and associated with respective downstream ports 104. In an example, an application of the SOC 110 generates an I/O message (e.g., a read request or a write request) addressed to the device 164AA. The SOC 110, based on the configuration data 130 indicating that the device 164AA is associated with the data EP 156A and that the downstream port 104A is assigned to the data EP 156A, selects the interface controller 114A that is coupled via the link controller 116A to the downstream port 104. The SOC 110 sends the I/O message to the interface controller 114A (e.g., the selected interface controller) via a data channel associated with the application, as further described with reference to FIGS. 5 and 9.

The interface controller 114A, based on the I/O message, generates an I/O request that is addressed to the data EP 156A and that also indicates the device 164AA, as further described with reference to FIGS. 5 and 9. The interface controller 114A, based on determining that the configuration data 130 indicates that the downstream port 104A is assigned to the first data EP group that includes the data EP 156A, sends the I/O request via the link controller 116A to the downstream port 104A, as further described with reference to FIGS. 5 and 9. The downstream port 104A sends the I/O request via the communication link 150A to the upstream port 154A of the target-side data interface device 152.

The interface controller 114A may also generate I/O requests for other devices 164 associated with the first data EP group and provide the I/O requests to the link controller 116A to be sent via the downstream port 104A and the communication link 150A to the upstream port 154A of the target-side data interface device 152. Communications to the group of devices 164A, coupled to the data EP 156A included in the first group of data EPs assigned to the downstream port 104A, are thus sent from (e.g., aggregated through) the downstream port 104A via the communication link 150A to the upstream port 154A. Similarly, communications to the group of devices 164B and the group of devices 164C, coupled to the second data EP group (e.g., the data EP 156B or the data EP 156) assigned to the downstream port 104B, are sent from (e.g., aggregated through) the downstream port 104B via the communication link 150B to the upstream port 154B.

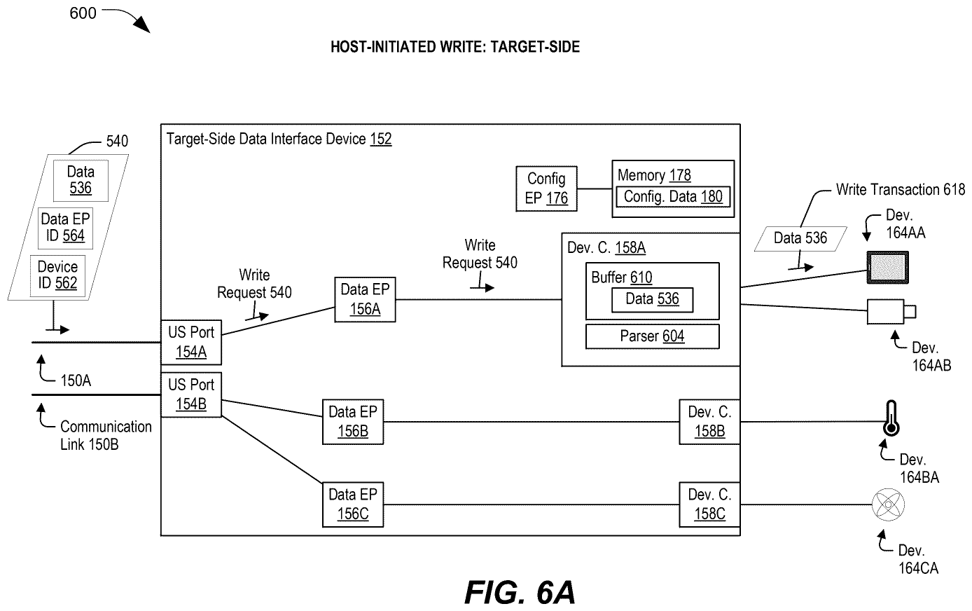

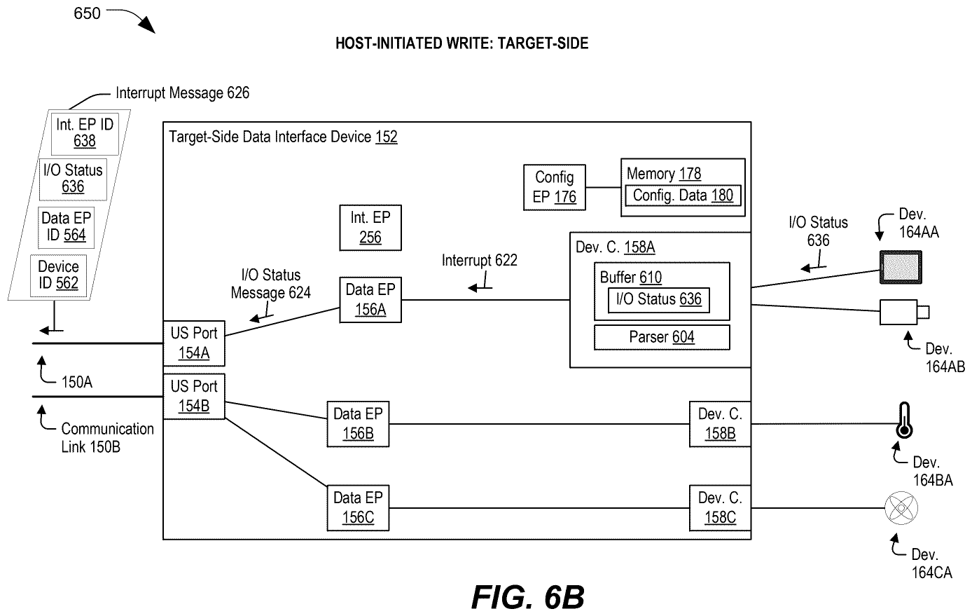

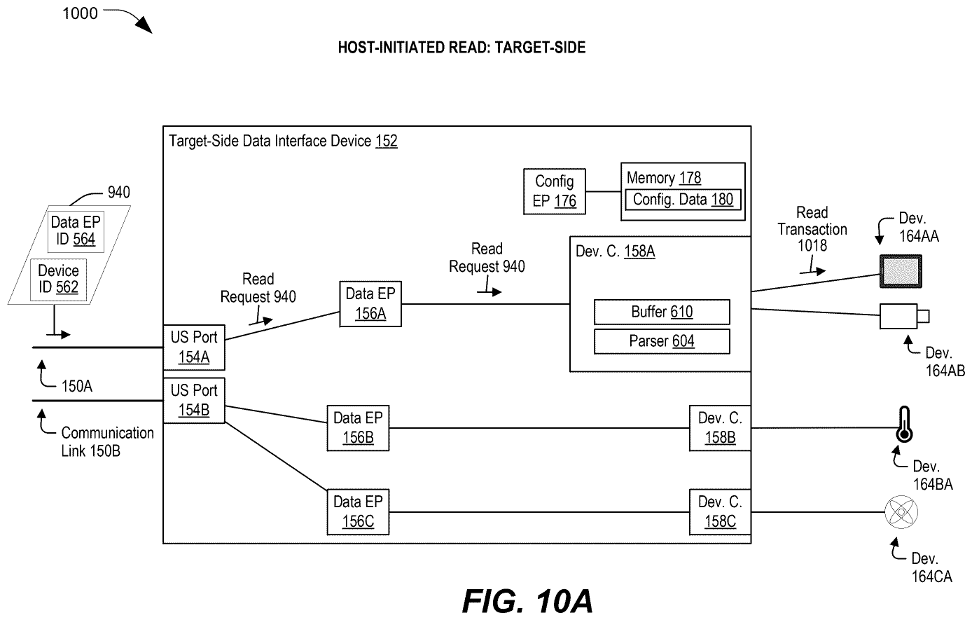

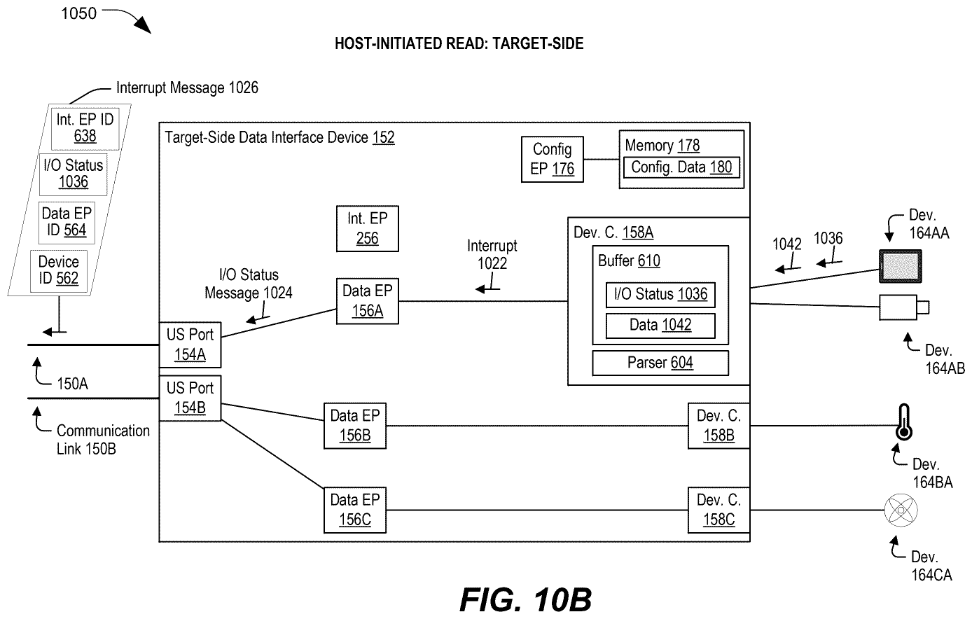

The upstream port 154A, based on determining that a received I/O request is addressed to the data EP 156A, provides the I/O request to the data EP 156A. The data EP 156A provides the I/O request to the device controller 158A to initiate an I/O operation at the device 164AA that corresponds to the I/O request, as further described with reference to FIGS. 6A and 10A.

Upon a notification from the device 164AA indicating completion of the I/O operation, the device controller 158A issues an interrupt to the data EP 156A indicating an I/O status, as further described with reference to FIGS. 6B and 10B. The data EP 156A sends an I/O status message indicating the I/O status to the upstream port 154A that is assigned to the data EP 156A. The upstream port 154A sends an interrupt message that indicates the I/O status via the communication link 150A to the downstream port 104A, as further described with reference to FIGS. 6B and 10B.

The data EP 156A may also send I/O statuses from other devices associated with the first data EP group to the upstream port 154A. Communications from the group of devices 164A are thus sent from (e.g., aggregated through) the upstream port 154A via the communication link 150A to the downstream port 104A. Similarly, communications from the group of devices 164B and the group of devices 164C are sent from (e.g., aggregated through) the upstream port 154B via the communication link 150B to the downstream port 104B.

The system 100 thus enables communication, between the SOC 110 and subsets of the devices 164, to be aggregated using the communication links 150. For example, communications between the SOC 110 and the group of devices 164A are aggregated through the communication link 150A. As another example, communications between the SOC 110 and the groups of devices 164B, 164C are aggregated through the communication link 150B.

A technical advantage of aggregating communications of a group of devices through a corresponding communication link includes reducing the number of communication links between the host-side data interface device 102 and the target-side data interface device 152, as compared to a dedicated communication link between a target-side data interface device and a host-side data interface device for each of the devices 164. In some examples, reducing the number of communication links between the host-side data interface device 102 and the target-side data interface device 152 can result in less bulky flex cables between the host-side data interface device 102 and the target-side data interface device 152, and a sleeker foldable device (e.g., the system 100).

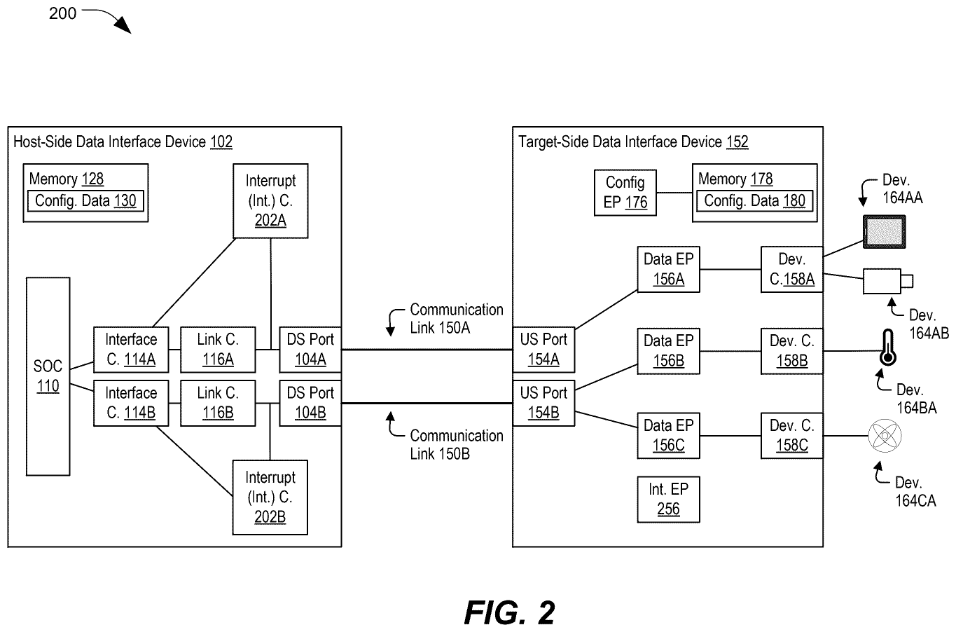

Referring to FIG. 2, a particular illustrative aspect of a system configured to enable communication between a target-side data interface device and a host-side data interface device is disclosed and generally designated 200. In a particular aspect, the system 200 includes one or more components described with reference to the system 100 of FIG. 1.

The host-side data interface device 102 includes a plurality of interrupt controllers 202, such as an interrupt controller 202A, an interrupt controller 202B, one or more additional interrupt controllers, or a combination thereof. Each interrupt controller 202 is coupled to a respective downstream port 104 and to a respective interface controller 114. In the example illustrated in FIG. 2, the interrupt controller 202A is coupled to the downstream port 104A and to the interface controller 114A. In this example, the interrupt controller 202B is coupled to the downstream port 104B and to the interface controller 114B.

Optionally, in some implementations, the target-side data interface device 152 includes an interrupt EP 256. Each of the EPs of the target-side data interface device 152 may be assigned a unique EP identifier. For example, each of the configuration EP 176, the data EPs 156, and the interrupt EP 256 is assigned a respective unique EP identifier.

During operation of the system 200, the device controller 158A issues an interrupt to the data EP 156A that includes an I/O status indicating that an I/O operation (e.g., a read operation or a write operation) is completed at the device 164AA, as described with reference to FIG. 1. The data EP 156A provides an I/O status message including the I/O status (e.g., read completed or write completed) to the upstream port 154A. The upstream port 154A generates an interrupt message that includes the I/O status and a pre-determined value (e.g., the EP identifier of the interrupt EP 256), as further described with reference to FIGS. 6B and 10B. The upstream port 154A sends the interrupt message via the communication link 150A to the downstream port 104A. The downstream port 104A outputs the interrupt message.

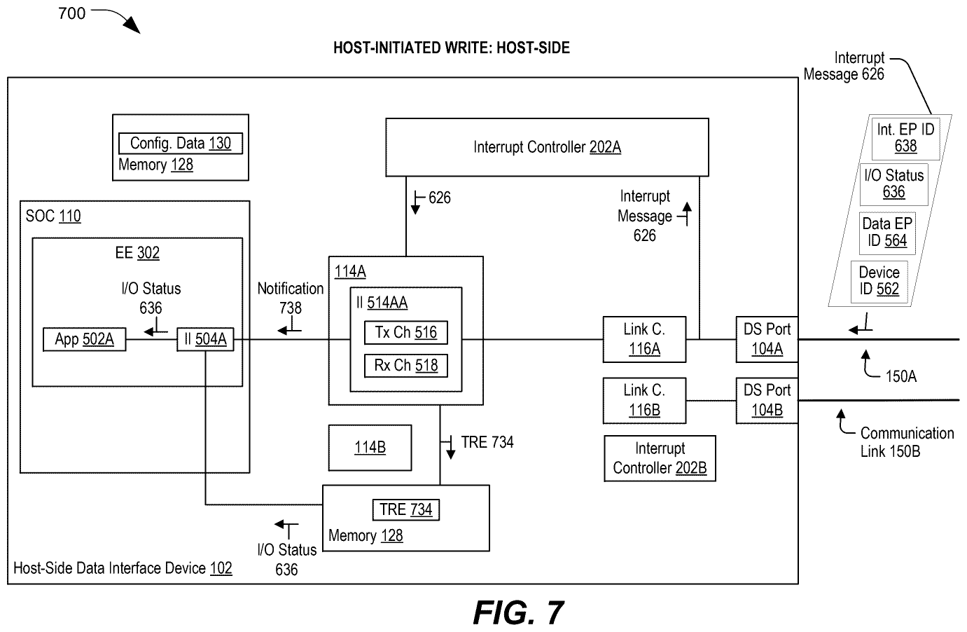

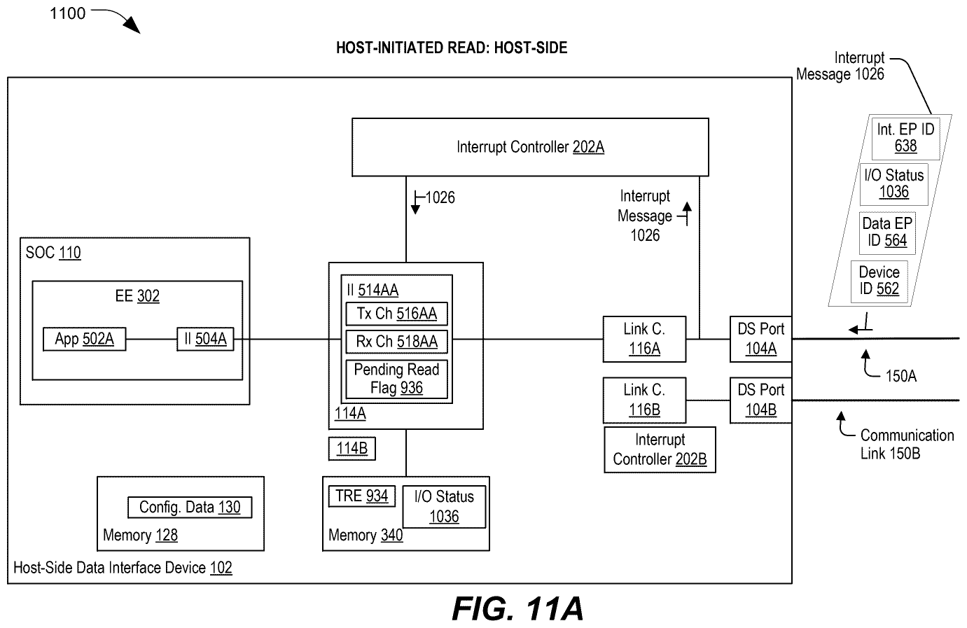

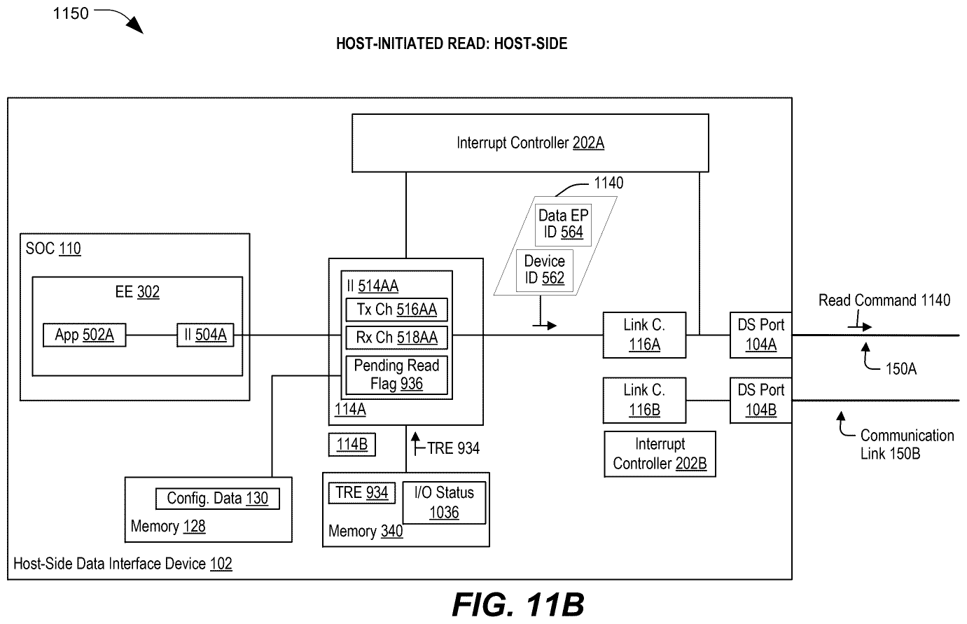

The interrupt controller 202A, coupled to the downstream port 104A, detects the interrupt message output by the downstream port 104A. The interrupt controller 202 selectively processes the interrupt message based on determining whether the interrupt message includes the pre-determined value (e.g., the EP identifier of the interrupt EP 356). For example, the interrupt controller 202, based on determining that the interrupt message includes the pre-determined value, provides the I/O status indicated in the interrupt message to the interface controller 114A that is coupled to the interrupt controller 202A, as further described with reference to FIGS. 7 and 11A.

In an example in which the I/O status from the data EP 156A indicates that a write operation has been completed, the interface controller 114A stores the I/O status in a memory and initiates one or more operations at the application associated with the data channel that is associated with the I/O status, as further described with reference to FIG. 7.

In an example in which the I/O status from the data EP 156A indicates that a read operation has been completed, the interface controller 114A sends a read command (e.g., a data retrieval request) addressed to the data EP 156A to retrieve data stored in a transmit buffer coupled to the data EP 156A, as further described with reference to FIG. 11B. A technical advantage of having the interface controller 114 initiating data retrieval from the data EP 156A without the SOC 110 having to be notified can include reduced read latency.

Referring to FIG. 3, an illustrative example is depicted of operations associated with configuration of a system 300, in accordance with some examples of the present disclosure. In a particular aspect, the system 300 includes one or more components of the system 100 of FIG. 1, the system 200 of FIG. 2, or both.

In some implementations, the host-side data interface device 102 may include one or more components depicted in the system 100 of FIG. 1, the system 200 of FIG. 2, or both, that are not depicted in FIG. 3 for ease of illustration. Similarly, in some implementations, the target-side data interface device 152 may include one or more components depicted in the system 100 of FIG. 1, the system 200 of FIG. 2, or both, that are not depicted in FIG. 3 for ease of illustration.

The SOC 110 supports one or more execution environments (EE) 302, such as an execution environment 302A, an execution environment 302B, an execution environment 302C, one or more additional execution environments, or a combination thereof. One or more applications 304 are configured to execute in an execution environment 302. In the example illustrated in FIG. 3, an application 304A is configured to execute in the execution environment 302A. In this example, an application 304B is configured to execute in the execution environment 302B.

The execution environment 302A includes a configuration I/O interface (II) 306 (e.g., a general purpose I/O interface (GPIO)). In the example illustrated in FIG. 3, the configuration II 306 (e.g., configuration II software) is coupled to a configuration II 308 (e.g., configuration II firmware) included in the interface controller 114A.

In some examples, the system 300 enters a configuration phase upon powering up, based on user input, or both. During the configuration phase, the SOC 110 (e.g., the configuration II 306) performs one or more set up operations. For example, the configuration II 306 performs set up of the link controllers 116 as communication controllers. As another example, the configuration II 306 loads specific firmware (e.g., the configuration II 308, other IIs, or a combination thereof) into memory (e.g., random access memory) associated with the interface controllers 114. In some examples, the configuration II 308, other IIs, or a combination thereof, initialize receive data channels and transmit data channels associated with the one or more applications 304 configured to execute in the one or more execution environments 302.

In a particular aspect, the configuration II 306 generates the configuration data 130 to include configuration information of the plurality of device controllers 158. In the example illustrated in FIG. 3, the configuration data 130 indicates that the data EP 156A is coupled via the device controller 158A to the device 164AA and the device 164AB, that the data EP 156B is coupled via the device controller 158B to the device 164BA, and that the data EP 156C is coupled via the device controller 158C to the device 164CA. Optionally, in some implementations, the configuration II 306, based on detecting a reconfiguration of a device controller 158, updates the configuration data 130 to indicate updated configuration information of the plurality of device controllers 158.

The interface controllers 114 associate with groups of data EPs 156 and update the configuration data 130 to indicate assignment of the downstream ports 104 to respective groups of data EPs 156. In the example illustrated in FIG. 3, the interface controller 114A is associated with a first data transfer speed of the communication link 150A. For example, the interface controller 114A is coupled via the link controller 116A and the downstream port 104A to the communication link 150A having the first data transfer speed. The interface controller 114A determines that the data EP 156A is associated with a first device type. For example, the interface controller 114A determines that the configuration data 130 indicates that the data EP 156A is coupled to the device controller 158A that is configured to couple to one or more devices of the first device type (e.g., high power devices), such as respective devices 164 that are configured to communicate with the SOC 110 during an active mode of the SOC 110 and are configured to not communicate with the SOC 110 during an inactive mode of the SOC 110. The interface controller 114A, based on determining that the interface controller 114A is associated with the first data transfer speed, that the data EP 156A is associated with the first device type, and that the configuration data 130 indicates that the first device type is associated with the first data transfer speed, determines that the data EP 156A is associated with the interface controller 114A. In some aspects, the interface controller 114A updates the configuration data 130 to indicate that the data EP 156A is included in a first group of data EPs assigned to the communication link 150A and corresponding ports (e.g., the downstream port 104A and the upstream port 154A).

In another example, the interface controller 114B is associated with a second data transfer speed of the communication link 150B. To illustrate, the interface controller 114B is coupled via the link controller 116B and the downstream port 104B to the communication link 150B having the second data transfer speed. The interface controller 114B determines that the data EP 156B is associated with a second device type. For example, the interface controller 114B determines that the configuration data 130 indicates that the data EP 156B is coupled to the device controller 158B that is configured to couple to one or more devices of the second device type (e.g., low power devices), such as respective devices 164 that are configured to communicate with the SOC 110 during an inactive mode of the SOC 110. Optionally, in some implementations, devices of the second device type can additionally be configured to communicate with the SOC 110 during an active mode of the SOC 110. The interface controller 114B, based on determining that the interface controller 114B is associated with the second data transfer speed, that the data EP 156B is associated with the second device type, and that the configuration data 130 indicates that the second device type is associated with the second data transfer speed, determines that the data EP 156B is associated with the interface controller 114B. Similarly, the interface controller 114B, based on determining that the interface controller 114B is associated with the second data transfer speed and that the configuration data 130 indicates that the data EP 156C is associated with the second device type and that the second device type is associated with the second data transfer speed, determines that the data EP 156C is associated with the interface controller 114B. In some aspects, the interface controller 114B updates the configuration data 130 to indicate that the data EP 156B and the data EP 156C are included in a second group of data EPs assigned to the communication link 150B and corresponding ports (e.g., the downstream port 104B and the upstream port 154B). In some implementations, the first data transfer speed of the communication link 150A is greater than a threshold speed, and the second data transfer speed of the communication link 150B is less than or equal to the threshold speed.

It should be understood that the interface controllers 114 associating with groups of data EPs 156 and updating the configuration data 130 to indicate the assignment of the downstream ports 104 to respective groups of data EPs 156 is provided as an illustrative example. In other examples, another component of the host-side data interface device 102, such as the configuration II 306, can associate the interface controllers 114 with groups of data EPs 156 and update the configuration data 130 to indicate the assignment of the downstream ports 104 to respective groups of data EPs 156.

It should be understood that assigning a data EP 156 to a respective communication link 150 based on a data transfer speed of the communication link 150 is provided as an illustrative example; in other examples, the assignment of the data EP 156 to a communication link 150 can be based on other factors, such as user input, a configuration setting, default data, etc. It should be understood that the communication link 150A having a first data transfer speed that is distinct from a second data transfer speed of the communication link 150B is provided as an illustrative example; in other examples the first data transfer speed can be the same as the second data transfer speed.

Optionally, in some implementations, the configuration II 306 updates the configuration data 130 to indicate device registration information of the one or more applications 304 of the SOC 110. In an illustrative example, the configuration II 306, based on a registration request from the application 304A to register for notifications from the device 164AA, updates the configuration data 130 to indicate that the application 304A is registered to receive notifications from the device 164AA. In another illustrative example, the configuration II 306, based on a registration request from the application 304A to register for notifications from a first device type (e.g., a display device), updates the configuration data 130 to indicate that the application 304A is registered to receive notifications from any devices 164 that are of the first device type.

The configuration II 306 generates configuration data 330 based on the configuration data 130. In some examples, the configuration data 330 includes at least a portion of the configuration data 130. For example, the configuration data 330 indicates assignment of the communication links 150 and corresponding ports to respective groups of data EPs, the device registration information of the one or more applications 304, the configuration information of the plurality of device controllers 158, or a combination thereof. The configuration II 306, to provide the configuration data 330 to the configuration II 308 to send to the target-side data interface device 152, generates a transaction request element (TRE) 342, stores the TRE 342 and the configuration data 330 in a memory 340 (e.g., a double data rate (DDR) memory), and sends a notification to the configuration II 308. In an example, sending the notification to the configuration II 308 corresponds to the configuration II 306 writing to a register of the configuration II 308.

In a particular aspect, the TRE 342 indicates that a data transfer is to be initiated, a location of the memory 340 where the data (e.g., the configuration data 330) is stored, a destination (e.g., an EP identifier of the configuration EP 176) of the data transfer, or a combination thereof. The configuration II 308, responsive to the notification, retrieves the TRE 342 from the memory 340 and generates, based on the TRE 342, a configuration EP write message 352 addressed to the configuration EP 176. For example, the configuration EP write message 352 includes the EP identifier of the configuration EP 176. The configuration II 308 provides the configuration EP write message 352 to the link controller 116A.

In some examples, the configuration EP write message 352 includes the configuration data 330. In other examples, the configuration EP write message 352 indicates a location of the configuration data 330 in the memory 340 and the link controller 116A retrieves the configuration data 330 from the memory 340. In some aspects, the configuration EP write message 352 indicates a memory location (e.g., register addresses) of the memory 178 that is to be updated based on the configuration data 330. The link controller 116A provides the configuration EP write message 352, including the configuration data 330, to the downstream port 104A. The downstream port 104A sends the configuration EP write message 352 via the communication link 150A to the upstream port 154A of the target-side data interface device 152.

The upstream port 154A receives the configuration EP write message 352 via the communication link 150A and provides the configuration EP write message 352 that is addressed to the configuration EP 176 to the configuration EP 176. The configuration EP 176 parses the configuration EP write message 352 to extract the configuration data 330 and uses the configuration data 330 to update the configuration data 180 in the memory 178.

In some aspects, the configuration EP 176, based on the assignments indicated in the configuration data 330, sends a configuration EP read message 354 to one or more of the data EPs 156. For example, the configuration EP 176, based on determining that the configuration data 330 indicates that the upstream port 154A is assigned to the data EP 156A, sends a configuration EP read message 354 to the data EP 156A indicating that the upstream port 154A is assigned to the data EP 156A. Optionally, in some implementations, the configuration EP 176 sends the configuration EP read message 534 to the data EP 156A in response to a read request from the data EP 156A. In some implementations, the data EP 156A, in response to the assignment indicated in the configuration EP read message 354, stores the assignment in a memory of the data EP 156A to route any future messages to the host-side data interface device 102 via the upstream port 154A. Similarly, the configuration EP 176 sends a configuration EP read message 354 to the data EP 156B indicating that the upstream port 154B is assigned to the data EP 156B and sends a configuration EP read message 354 to the data EP 156C indicating that the upstream port 154B is assigned to the data EP 156C. Optionally, in some implementations, the configuration EP 176 sends the same configuration EP read message 534 to multiple data EPs 156 and the configuration EP read message 534 indicates assignment of respective ports 154 to the data EPs 156.

In some aspects, assignment of the communication links 150 and corresponding ports to respective groups of data EPs can be updated based on user input, a reconfiguration of a device controller, or both. In an example, the configuration II 306, in response to detecting that the configuration data 130 is updated to indicate that the device controller 158C is reconfigured to couple to one or more devices of the first device type (e.g., high power devices), initiates sending of a configuration EP write message 352 indicating that the data EP 156C is included in the first group of data EPs assigned to the communication link 150A and corresponding ports. The configuration EP 176 updates the configuration data 180 responsive to the configuration EP write message 352 and sends a configuration EP read message 354 to the data EP 156C indicating that the upstream port 154A is assigned to the data EP 156C. The data EP 156C routes future messages to the host-side data interface device 102 via the upstream port 154A.

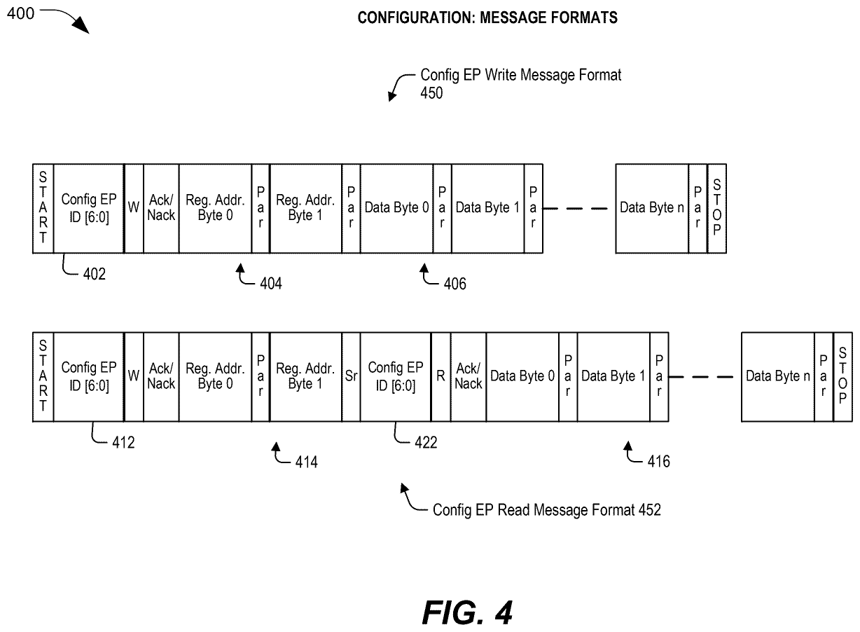

Referring to FIG. 4, an example 400 is depicted of message formats of messages exchanged during the configuration described with reference to FIG. 3, in accordance with some examples of the present disclosure. For example, a configuration EP write message format 450 can correspond to a format of the configuration EP write message 352 of FIG. 3. As another example, a configuration EP read message format 452 can correspond to a format of the configuration EP read message 354 of FIG. 3.

The configuration EP write message format 450 includes a plurality of fields. For example, the configuration EP write message format 450 may include a configuration EP identifier field 402, registration address fields 404, and data fields 406. In a particular aspect, the configuration EP write message 352 of FIG. 3 includes an EP identifier of the configuration EP 176 in the configuration EP identifier field 402, addresses of registers of the memory 178 in the registration address fields 404, and the configuration data 330 in the data fields 406.

The configuration EP read message format 452 includes a plurality of fields. For example, the configuration EP read message format 452 may include a configuration EP identifier field 412, register address fields 414, a configuration EP identifier field 422, and data fields 416. In a particular aspect, the configuration EP read message 354 of FIG. 3 to the data EP 156A includes an EP identifier of the configuration EP 176 in the configuration EP identifier field 412, addresses of registers of a memory of the data EP 156A in the register address fields 414, the EP identifier of the configuration EP 176 in the configuration EP identifier field 422, and assignment data in the data fields 416 indicating that the upstream port 154A is assigned to the data EP 156A. In some examples, the configuration EP identifier field 412 indicates a source of data to be written to a destination indicated by the register address fields 414. In some examples, the configuration EP identifier field 422 indicates a source from which data included in the data fields 416 is read.

Referring to FIG. 5, an illustrative example 500 is depicted of operations at the host-side data interface device 102 that are associated with a host-initiated write, in accordance with some examples of the present disclosure. The SOC 110 includes an execution environment 302. One or more applications 502, such as an application 502A, an application 502B, one or more additional applications, or a combination thereof, are configured to execute in the execution environment 302. In a particular aspect, the applications 502 correspond to the applications 304 of FIG. 3.

In some aspects, the execution environment 302 corresponds to the execution environment 302A of FIG. 3 that includes the configuration II 306. In some other aspects, the execution environment 302 corresponds to one of the execution environment 302B or the execution environment 302C of FIG. 3.

Each application 502 of the execution environment 302 is coupled to an II 504 (e.g., a software I/O interface). For example, the application 502A is coupled to an II 504A, the application 502B is coupled to an II 504B, one or more additional applications 502 are coupled to respective I/O interfaces 504, or a combination thereof.

Each of the interface controllers 114 includes IIs 514 (e.g., firmware I/O interfaces) associated with respective IIs 504 (e.g., software I/O interfaces). For example, the interface controller 114A includes an II 514AA and the interface controller 114B includes an II 514AB. Each of the II 514AA and the II 514AB is coupled to the II 504A associated with the application 502A. As another example, the interface controller 114A includes an II 514BA and the interface controller 114B includes an II 514BB. Each of the II 514BA and the II 514BB is coupled to the II 504B associated with the application 502B.

Each of the IIs 514 includes a transmit data channel 516 and a receive data channel 518 of a corresponding application 502 that are associated communication link 150. For example, the II 514AA includes a transmit data channel 516AA and a receive data channel 518AA of the application 502A that are associated with the communication link 150A. As another example, the II 514AB includes a transmit data channel 516AB and a receive data channel 518AB of the application 502A that are associated with the communication link 150B. In some aspects, the transmit data channels 516 and the receive data channels 518 are set up during the configuration phase, described with reference to FIG. 3.

During execution of the application 502A, the application 502A generates a write message 532 indicating that data 536 is to be written to the device 164AA having the device identifier 562. In an example, the write message 532 includes the data 536 and is addressed to the device 164AA. To illustrate, the write message 532 includes the device identifier 562 as a destination address, and the device identifier 562 corresponds to the device 164AA. The application 502A provides the write message 532 to the II 504A associated with the application 502A.

The II 504A stores the data 536 at a first memory location of the memory 340 and selects one of the IIs 514A associated with the application 502A. For example, the II 504A, based on determining that the configuration data 130 indicates that the device 164AA is coupled to the data EP 156A and that the upstream port 154A coupled to the communication link 150A is assigned to the data EP 156A, selects the II 514AA associated with the communication link 150A. The II 504A generates a TRE 534 that indicates that a transfer is to be performed of the data 536 stored in the first memory location of the memory 340 to the device 164AA having the device identifier 562. The II 504A stores the TRE 534 in a second location of the memory 340 and sends a notification 538 associated with the transmit data channel 516AA to the selected II 514AA. In a particular aspect, sending the notification 538 to the II 514AA corresponds to writing to a register of the II 514AA associated with the transmit data channel 516AA. The write message 532 is thus associated with the transmit data channel 516AA. In a particular aspect, the notification 538 indicates that the TRE 534 is stored at the second location of the memory 340.

The II 514AA, responsive to receiving the notification 538, obtains the TRE 534 from the second location of the memory 340 and generates a write request 540 based on the TRE 534. For example, the II 514AA, based on determining that the TRE 534 indicates that the write request 540 is to be sent to the device 164AA, generates the write request 540 addressed to the device 164AA. To illustrate, the write request 540 includes the device identifier 562 of the device 164AA. Additionally, the II 514AA, based on determining that the configuration data 130 indicates that the device 164AA is coupled to the data EP 156A and that the data EP 156A has a data EP identifier 564, generates the write request 540 to indicate the data EP identifier 564 of the data EP 156A.

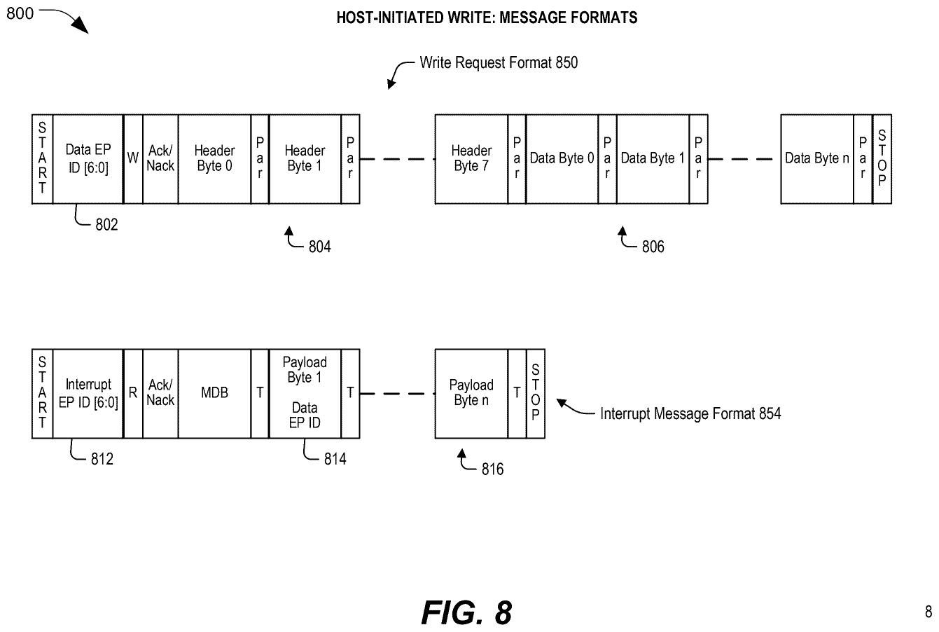

In some aspects, the II 514AA, based on a determination that the configuration data 130 indicates that a first communication protocol of a plurality of communication protocols is associated with the data EP 156A, generates the write request 540 to include a header that includes one or more fields that are associated with the first communication protocol, as further described with reference to FIGS. 8 and 17-20. The header has a pre-determined length that is communication protocol-independent.

In a particular aspect, the II 514AA generates the write request 540 to indicate the first location of the memory 340 where the data 536 is stored. The II 514AA, based on determining that the configuration data 130 indicates that the device 164AA having the device identifier 562 is coupled to the data EP 156A and that the data EP 156A is assigned to the downstream port 104A coupled to the communication link 150A, sends the write request 540 via the link controller 116A to the downstream port 104A. For example, the II 514AA sends the write request 540 to the link controller 116A. The link controller 116A obtains the data 536 from the first location of the memory 340, adds the data 536 to the write request 540, and sends the write request 540 via the downstream port 104A and the communication link 150A to the target-side data interface device 152. In a particular aspect, sending the write request 540 includes sending, via the communication link 150A, the data EP identifier 564 followed by the header of the write request 540 that is followed by the data 536.

Referring to FIG. 6A, an illustrative example 600 is depicted of operations at the target-side data interface device 152 that are associated with the host-initiated write, in accordance with some examples of the present disclosure. The upstream port 154A, responsive to receiving the write request 540 via the communication link 150A and determining that the write request 540 includes the data EP identifier 564 of the data EP 156A, sends the write request 540 to the data EP 156A.

In some aspects, receiving the write request 540 at the upstream port 154A includes receiving, via the communication link 150A, the data EP identifier 564 followed by the header of the write request 540 that is followed by the data 536. The upstream port 154A, responsive to receiving the data EP identifier 564 of the data EP 156A, sends the header of the write request 540 and the data 536 to the data EP 156A.

The data EP 156A provides the write request 540 to the device controller 158A. For example, the data EP 156A provides a header of the write request 540 to a parser 604 of the device controller 158A, extracts the data 536 from a payload of the write request 540, and stores the data 536 in a buffer 610 of the device controller 158A. The parser 604, based on determining that the header indicates the device identifier 562 of the device 164AA, initiates a write transaction 618 to write the data 536 to the device 164AA. In some examples, the device 164AA includes a display device and the data 536 corresponds to an update of content displayed at the display device. The write transaction 618 initiates one or more write operations at the device 164AA.

While the I/O operations (e.g., write operations or read operations) are being performed at the device 164AA, the host-side data interface device 102 can initiate additional I/O operations at one or more devices 164 that are coupled to other data EPs 156, such as the data EP 156B or the data EP 156C. In a first example, the host-side data interface device 102 sends, via the communication link 150B to the target-side data interface device 152, a second I/O request (e.g., a write request 540 or a read request) that indicates a second data EP identifier of the data EP 156B and a second device identifier of the device 164BA. In some aspects, the second I/O request is responsive to an I/O message from the application 502A. In other aspects, the second I/O request is responsive to an I/O message from the application 502B in the same execution environment 302 or from an application in another execution environment of the SOC 110.

The upstream port 154B sends the second I/O request to the data EP 156B and the data EP 156B sends the second I/O request to the device controller 158B. The device controller 158B initiates an I/O transaction at the device 164BA. In a particular aspect, the second I/O request is received at the upstream port 154B subsequent to initiating the write transaction 618 at the device 164AA and prior to receiving an I/O status from the device 164AA corresponding to performance or completion of the write transaction 618. The communication link 150A and the communication link 150B can thus be used to concurrently initiate I/O transactions at distinct devices 164.

In a second example, the host-side data interface device 102 sends, via the communication link 150B to the target-side data interface device 152, a third I/O request (e.g., a write request 540 or a read request) that indicates a third data EP identifier of the data EP 156C and a third device identifier of the device 164CA. In a particular aspect, the third I/O request is received at the upstream port 154B subsequent to initiating the I/O transaction at the device 164BA, and prior to receiving an I/O status from the device 164BA corresponding to the I/O transaction. In some aspects, the third I/O request is responsive to an I/O message from the application 502A. In other aspects, the third I/O request is responsive to an I/O message from the application 502B in the same execution environment 302 as the application 502A, or from an application in another execution environment of the SOC 110.

The upstream port 154B sends the third write request 540 to the data EP 156C and the data EP 156C sends the third I/O request to the device controller 158C. The device controller 158C initiates an I/O transaction at the device 164CA. The same communication link can thus be used to concurrently initiate I/O transactions at distinct devices 164.

Referring to FIG. 6B, an illustrative example 650 is depicted of additional operations at the target-side data interface device 152 that are associated with the host-initiated write, in accordance with some examples of the present disclosure. The device controller 158A receives, from the device 164AA, an I/O status 636 of the one or more write operations corresponding to the write transaction 618. In an example, the I/O status 636 indicates whether the one or more write operations were completed successfully.

The device controller 158A stores the I/O status 636 associated with the device 164AA in the buffer 610 or a register, and issues an interrupt 622 to the data EP 156A. The data EP 156A, responsive to the interrupt 622, obtains the I/O status 636 from the device controller 158A and generates an I/O status message 624 based on the I/O status 636. For example, the I/O status message 624 includes the I/O status 636 and the device identifier 562 of the device 164AA. The data EP 156A, based on determining that the upstream port 154A is assigned to the data EP 156A, sends the I/O status message 624 to the upstream port 154A and instructs the upstream port 154A to generate an interrupt message 626 with the I/O status 636.

The upstream port 154A, responsive to receiving the I/O status message 624 from the data EP 156A, generates the interrupt message 626 based on the I/O status message 624. For example, the interrupt message 626 includes the I/O status 636 and the device identifier 562. In a particular aspect, the upstream port 154A generates the interrupt message 626 to include the data EP identifier 564 of the data EP 156A and also include a pre-determined value (e.g., an interrupt EP identifier 638 of the interrupt EP 256) that identifies the interrupt message 626 as being of an interrupt message type that is to be processed by an interrupt controller 202 of the host-side data interface device 102. The upstream port 154A sends the interrupt message 626 via the communication link 150A to the host-side data interface device 102. The pre-determined value (e.g., the interrupt EP identifier 638) is included in the interrupt message 626 to cause the interrupt controller 202A of the host-side data interface device 102 to process the interrupt message 626. For example, the interrupt controller 202A of the host-side data interface device 102, based on determining that the interrupt message 626 includes the pre-determined value, provides the interrupt message 626 to the interface controller 114A, as further described with reference to FIG. 7.

In a first example in which the device controller 158B initiates an I/O transaction at the device 164BA in addition to the I/O transaction initiated at the device 164AA by the device controller 158A, the device controller 158B receives a second I/O status from the device 164BA and issues a second interrupt to the data EP 156B. The data EP 156B, responsive to the second interrupt, generates a second I/O status message indicating the second I/O status and sends the second I/O status message to the upstream port 154B. The upstream port 154B generates a second interrupt message indicating the second I/O status and sends the second interrupt message via the communication link 150B to the host-side data interface device 102.

In a second example in which the device controller 158C initiates an I/O transaction at the device 164CA in addition to the I/O transaction initiated at the device 164AA by the device controller 158A, the device controller 158C receives a third I/O status from the device 164CA and issues a third interrupt to the data EP 156C. The data EP 156C, responsive to the third interrupt, generates a third I/O status message indicating the third I/O status and sends the third I/O status message to the upstream port 154B. The upstream port 154B generates a third interrupt message indicating the third I/O status and sends the third interrupt message via the communication link 150B to the host-side data interface device 102.

Referring to FIG. 7, an illustrative example 700 is depicted of additional operations at the host-side data interface device 102 that are associated with the host-initiated write, in accordance with some examples of the present disclosure. The downstream port 104A receives the interrupt message 626 via the communication link 150A and outputs the interrupt message 626. The interrupt controller 202A detects the interrupt message 626 output by the downstream port 104A.

The interrupt controller 202A selectively, based on determining whether the interrupt message 626 includes the pre-determined value (e.g., the interrupt EP identifier 638), processes the interrupt message 626. For example, the interrupt controller 202A, based on determining that the interrupt message 626 includes the pre-determined value, provides the interrupt message 626 to the interface controller 114A associated with the downstream port 104A. The interface controller 114A, based on determining that the interrupt message 626 includes the device identifier 562 of the device 164AA and that the configuration data 130 indicates that the application 502A is registered to be notified of interrupts associated with the device 164AA or a device type (e.g., a display device type) of the device 164AA, provides at least a portion of the interrupt message 626 (e.g., the I/O status 636, the device identifier 562, the data EP identifier 564, or a combination thereof) to the II 514AA associated with the application 502A.

The II 514AA generates a TRE 734 based on at least the portion of the interrupt message 626. For example, the TRE 734 includes the I/O status 636, the device identifier 562, or both. In a particular aspect, the II 514AA, based on determining that the I/O status 636 corresponds to a write operation, determines that the I/O status 636 is associated with the transmit data channel 516AA. The II 514AA, based on determining that the I/O status 636 is associated with the transmit data channel 516AA, stores the TRE 734 in the memory 128 and sends a notification 738 to the II 504A. For example, the II 514AA issues an interrupt as the notification 738 to the II 504A.

The II 504A, responsive to the notification 738, retrieves at least one of the I/O status 636 or the device identifier 562 from the memory 128 and initiates one or more operations at the application 502A being executed at the host-side data interface device 102. For example, the II 514AA provides the at least one of the I/O status 636 or the device identifier 562 to the application 502A, and the application 502A initiates one or more operations based on the I/O status 636, the device identifier 562, or both.

Referring to FIG. 8, an example 800 is depicted of message formats of messages exchanged during a host-initiated write described with reference to FIGS. 5-7, in accordance with some examples of the present disclosure. For example, a write request format 850 can correspond to a format of the write request 540 of FIG. 5. As another example, an interrupt message format 854 can correspond to a format of the interrupt message 626 of FIG. 6B.

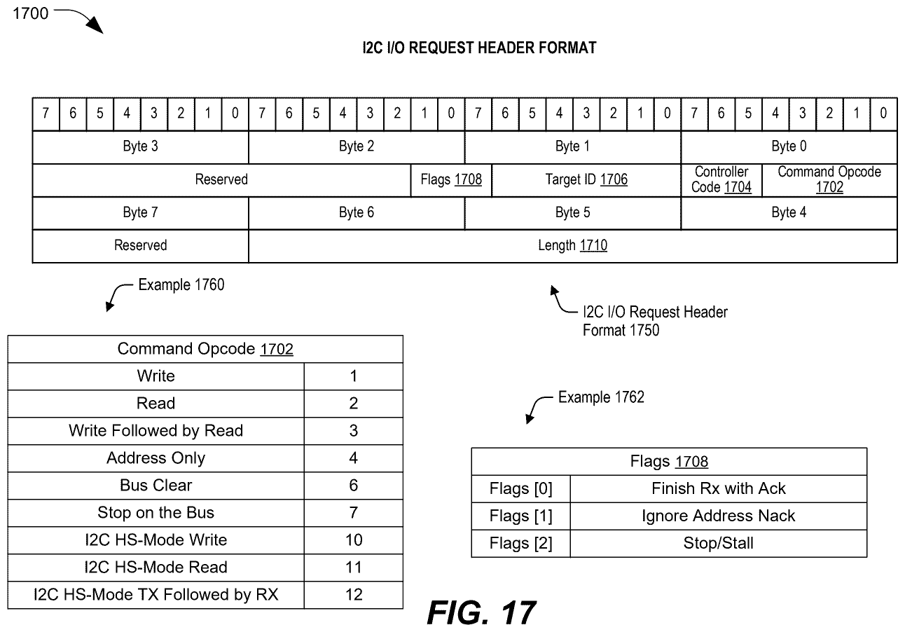

The write request format 850 includes a plurality of fields. For example, the write request format 850 includes a data EP identifier field 802, header fields 804, and data fields 806. In a particular aspect, the write request 540 of FIG. 5 includes the data EP identifier 564 of the data EP 156A in the data EP identifier field 802 and the data 536 in the data fields 806. The header fields 804 include values that are based on a communication protocol of the data EP 156A, as further described with reference to FIGS. 17-20. In a particular aspect, the write request 540 includes the device identifier 562 in at least a portion of the header fields 804. In a particular aspect, the header fields 804 have a pre-determined length (e.g., 8 bytes) that is communication protocol-independent.

The interrupt message format 854 includes an interrupt EP identifier field 812, data EP identifier field 814 (e.g., a first payload field), and payload fields 816 (e.g., remaining payload fields). In a particular aspect, the interrupt message 626 of FIG. 6B includes the interrupt EP identifier 638 of the interrupt EP 256 in the interrupt EP identifier field 812, the data EP identifier 564 in the data EP identifier field 814, and the I/O status 636 in at least a portion of the payload fields 816. In a particular aspect, the interrupt message 626 includes the device identifier 562 in at least a portion of the payload fields 816.

Referring to FIG. 9, an illustrative example 900 is depicted of operations at the host-side data interface device 102 that are associated with a host-initiated read, in accordance with some examples of the present disclosure.

During execution of the application 502A, the application 502A generates a read message 932 addressed to the device 164AA indicating that data is to be read from the device 164AA having the device identifier 562. To illustrate, the read message 932 includes the device identifier 562 as a destination address. The application 502A provides the read message 932 to the II 504A associated with the application 502A.

The II 504A selects one of the IIs 514A associated with the application 502A, as described with reference to FIG. 5. For example, the II 504A, based on determining that the configuration data 130 indicates that the device 164AA is coupled to the data EP 156A and that the upstream port 154A coupled to the communication link 150A is assigned to the data EP 156A, selects the II 514AA associated with the communication link 150A. The II 504A generates a TRE 934 that indicates that a transfer is to be performed of data from the device 164AA having the device identifier 562. The II 504A stores the TRE 934 associated with the receive data channel 518AA in a first location of the memory 340 and sends a notification 938 associated with the receive data channel 518AA to the selected II 514AA. In a particular aspect, sending the notification 938 to the II 514AA corresponds to writing to a register of the II 514AA associated with the receive data channel 518AA. The read message 932 is thus associated with the receive data channel 518AA. In a particular aspect, the notification 938 indicates that the TRE 934 is stored at the first location of the memory 340.

The II 514AA, responsive to receiving the notification 938, obtains the TRE 934 from the first location of the memory 340, generates a read request 940 based on the TRE 934. For example, the II 514AA, based on determining that the TRE 934 indicates that the read request 940 is to be sent to the device 164AA, generates the read request 940 addressed to the device 164AA. To illustrate, the read request 940 includes the device identifier 562 of the device 164AA. Additionally, the II 514AA, based on determining that the configuration data 130 indicates that the device 164AA is coupled to the data EP 156A and that the data EP 156A has a data EP identifier 564, generates the read request 940 to indicate the data EP identifier 564 of the data EP 156A.

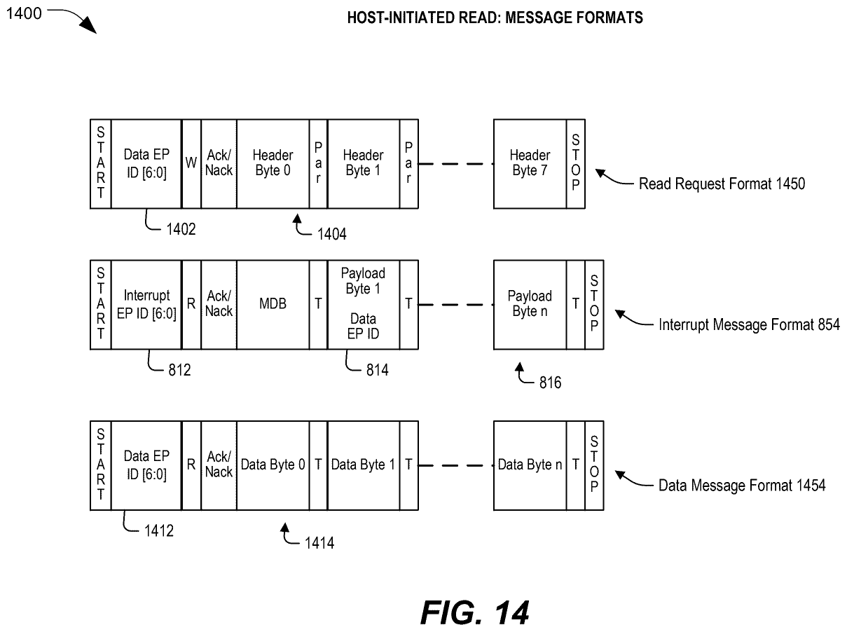

In some aspects, the II 514AA, based on a determination that the configuration data 130 indicates that a communication protocol of a plurality of communication protocols is associated with the data EP 156A, generates the read request 940 to include a header that includes one or more fields that are associated with the communication protocol, as further described with reference to FIGS. 14 and 17-20. The header has a pre-determined length that is communication protocol-independent.

In a particular aspect, the II 514AA, based on determining that the configuration data 130 indicates that the device 164AA having the device identifier 562 is coupled to the data EP 156A and that the data EP 156A is assigned to the downstream port 104A coupled to the communication link 150A, sets a pending read flag 936 to a first value (e.g., 1) to indicate that a read is pending and sends the read request 940 via the link controller 116A to the downstream port 104A. The downstream port 104A sends the read request 940 via the communication link 150A to the target-side data interface device 152. In a particular aspect, sending the read request 940 includes sending, via the communication link 150A, the data EP identifier 564 followed by the header of the read request 940.

Referring to FIG. 10A, an illustrative example 1000 is depicted of operations at the target-side data interface device 152 that are associated with the host-initiated read, in accordance with some examples of the present disclosure. The upstream port 154A, responsive to receiving the read request 940 via the communication link 150A and determining that the read request 940 includes the data EP identifier 564 of the data EP 156A, sends the read request 940 to the data EP 156A.

In some aspects, receiving the read request 940 at the upstream port 154A includes receiving, via the communication link 150A, the data EP identifier 564 followed by the header of the read request 940. The upstream port 154A, responsive to receiving the data EP identifier 564 of the data EP 156A, sends the read request 940 (e.g., including the header) to the data EP 156A.

The data EP 156A provides the read request 940 to the device controller 158A. The parser 604, based on determining that the header of the read request 940 indicates the device identifier 562 of the device 164AA, initiates a read transaction 1018 to read data from the device 164AA. In some examples, the device 164AA includes a touch screen device and the data corresponds to user input from the touch screen device. The read transaction 1018 initiates one or more read operations at the device 164AA. While the read operations are being performed at the device 164AA, the host-side data interface device 102 can initiate additional I/O operations at one or more devices 164 that are coupled to other data EPs 156, such as the data EP 156B or the data EP 156C.

Referring to FIG. 10B, an illustrative example 1050 is depicted of additional operations at the target-side data interface device 152 that are associated with the host-initiated read, in accordance with some examples of the present disclosure. The device controller 158A receives, from the device 164AA, data 1042 and an I/O status 1036 of the one or more read operations corresponding to the read transaction 1018. In an example, the I/O status 1036 indicates whether the one or more read operations were completed successfully.

The device controller 158A stores the data 1042 in the buffer 610, stores the I/O status 1036 associated with the device 164AA in the buffer 610 or a register, and issues an interrupt 1022 to the data EP 156A. The data EP 156A, responsive to the interrupt 1022, obtains the I/O status 1036 from the device controller 158A and generates an I/O status message 1024 based on the I/O status 1036. For example, the I/O status message 1024 includes the I/O status 1036 and the device identifier 562 of the device 164AA. The data EP 156A, based on determining that the upstream port 154A is assigned to the data EP 156A, sends the I/O status message 1024 to the upstream port 154A and instructs the upstream port 154A to generate an interrupt message 1026 with the I/O status 1036.

The upstream port 154A, responsive to receiving the I/O status message 1024 from the data EP 156A, generates the interrupt message 1026 based on the I/O status message 1024, as described with reference to FIG. 6B. For example, the interrupt message 1026 includes the I/O status 1036 and the device identifier 562. The upstream port 154A generates the interrupt message 1026 to include the data EP identifier 564 of the data EP 156A and also include a pre-determined value (e.g., the interrupt EP identifier 638 of the interrupt EP 256) that identifies the interrupt message 1026 as being of an interrupt message type that is to be processed by an interrupt controller 202 of the host-side data interface device 102. The upstream port 154A sends the interrupt message 1026 via the communication link 150A to the host-side data interface device 102. The pre-determined value (e.g., the interrupt EP identifier 638) is included in the interrupt message 1026 to cause the interrupt controller 202A of the host-side data interface device 102 to process the interrupt message 1026. For example, the interrupt controller 202A of the host-side data interface device 102, based on determining that the interrupt message 1026 includes the pre-determined value, provides the interrupt message 1026 to the interface controller 114A, as further described with reference to FIG. 11A.

Referring to FIG. 11A, an illustrative example 1100 is depicted of additional operations at the host-side data interface device 102 that are associated with the host-initiated read, in accordance with some examples of the present disclosure. The downstream port 104A receives the interrupt message 1026 via the communication link 150A and outputs the interrupt message 1026. The interrupt controller 202A detects the interrupt message 1026 output by the downstream port 104A.

The interrupt controller 202A selectively, based on determining whether the interrupt message 1026 includes the pre-determined value (e.g., the interrupt EP identifier 638), processes the interrupt message 1026. For example, the interrupt controller 202A, based on determining that the interrupt message 1026 includes the pre-determined value, provides the interrupt message 1026 to the interface controller 114A associated with the downstream port 104A. The interface controller 114A, based on determining that the interrupt message 1026 includes the device identifier 562 of the device 164AA, and that the configuration data 130 indicates that the application 502A is registered to be notified of interrupts associated with the device 164AA or a device type (e.g., a display device type) of the device 164AA, provides at least a portion of the interrupt message 1026 (e.g., the I/O status 1036, the device identifier 562, or both) to the II 514AA associated with the application 502A.

Referring to FIG. 11B, an illustrative example 1150 is depicted of additional operations at the host-side data interface device 102 that are associated with the host-initiated read, in accordance with some examples of the present disclosure.

The II 514AA, responsive to receiving at least the portion of the interrupt message 1026 and determining that the I/O status 1036 corresponds to a read operation, determines that the I/O status 1036 is associated with the receive data channel 518AA of the application 502A. The II 514AA, based on determining that the pending read flag 936 has a first value (e.g., 1) indicating that the receive data channel 518AA has a pending read operation, retrieves the TRE 934 associated with the receive data channel 518AA from the memory 340, and generates a read command 1140 based on the TRE 934. For example, the read command 1140 includes the data EP identifier 564, the device identifier 562, or both. The II 514AA provides the read command 1140 via the link controller 116A to the downstream port 104A. The downstream port 104A sends the read command 1140 via the communication link 150A to the target-side data interface device 152.

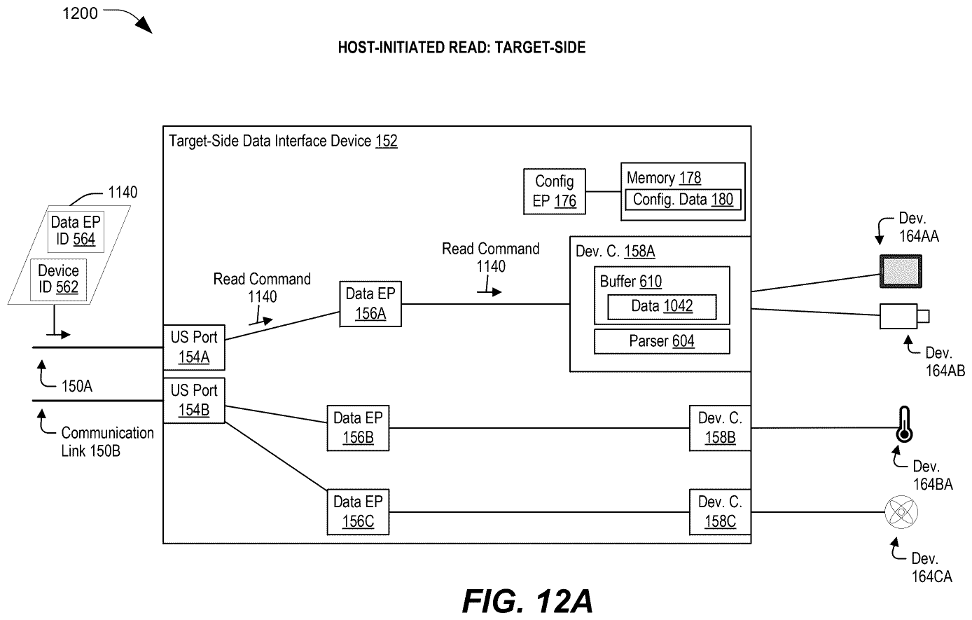

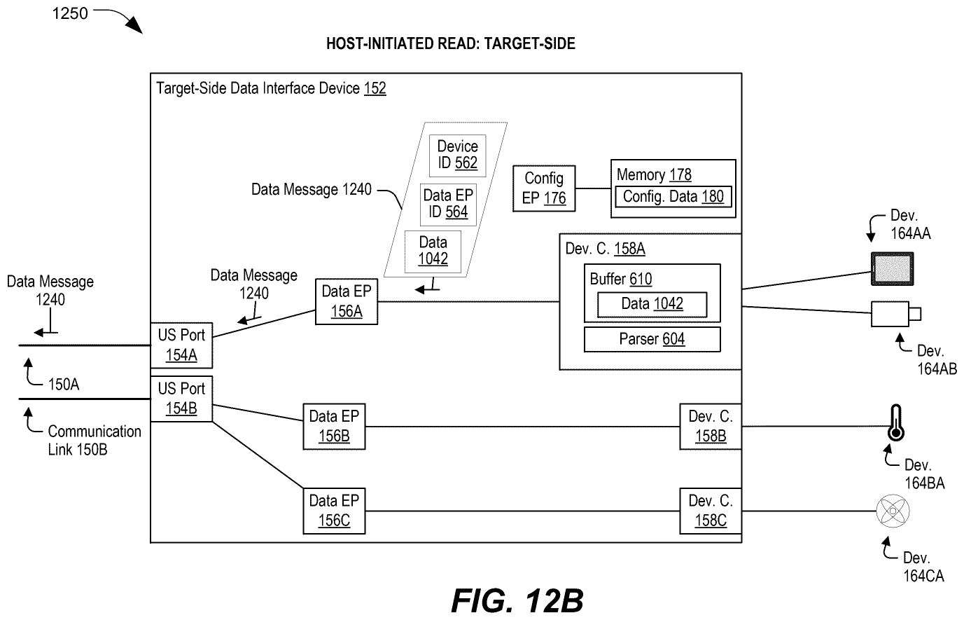

Referring to FIG. 12A, an illustrative example 1200 is depicted of additional operations at the target-side data interface device 152 that are associated with the host-initiated read, in accordance with some examples of the present disclosure. The upstream port 154A, responsive to receiving the read command 1140 via the communication link 150A and determining that the read command 1140 includes the data EP identifier 564 of the data EP 156A, sends the read command 1140 to the data EP 156A. The data EP 156A sends the read command 1140 to the device controller 158A.

Referring to FIG. 12B, an illustrative example 1250 is depicted of additional operations at the target-side data interface device 152 that are associated with the host-initiated read, in accordance with some examples of the present disclosure. The device controller 158A, responsive to receiving the read command 1140 indicating the device identifier 562, retrieves the data 1042 associated with the device 164AA from the buffer 610 and generates a data message 1240 that includes the data 1042. In some aspects, the data message 1240 indicates the data EP identifier 564, the device identifier 562, or both. The device controller 158A provides the data message 1240 to the data EP 156A.

The data EP 156A, based on determining that the upstream port 154A is assigned to the data EP 156A, sends the data message 1240 to the upstream port 154A. The upstream port 154A sends the data message 1240 via the communication link 150A to the host-side data interface device 102.

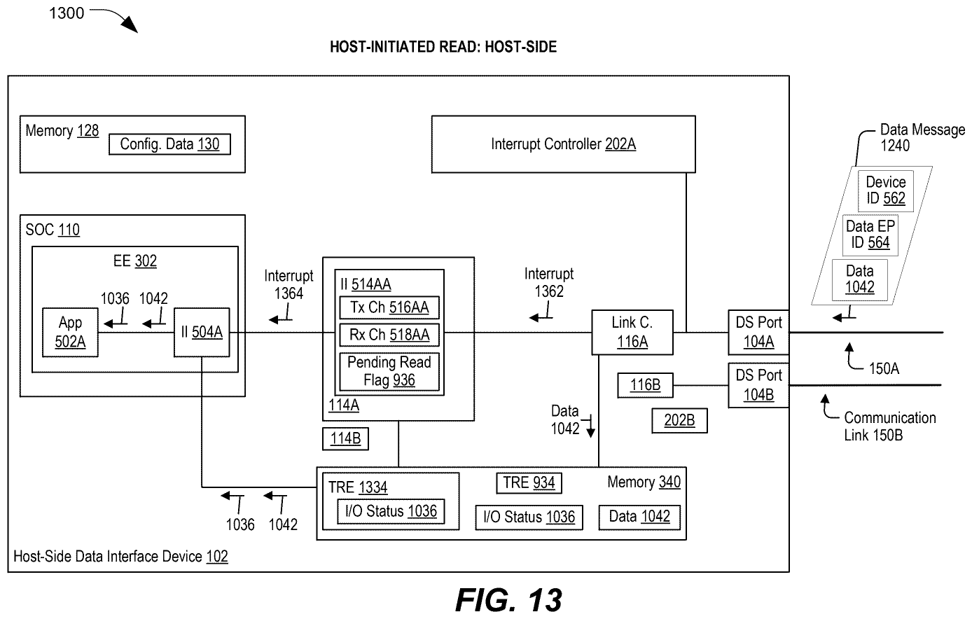

Referring to FIG. 13, an illustrative example 1300 is depicted of additional operations at the host-side data interface device 102 that are associated with the host-initiated read, in accordance with some examples of the present disclosure. The downstream port 104A receives the data message 1240 via the communication link 150A and outputs the data message 1240 to the link controller 116A.

In some aspects, the interrupt controller 202A detects the data message 1240 output by the downstream port 104A and, based on determining that the data message 1240 does not indicate the pre-determined value (e.g., the interrupt EP identifier 638), refrains from processing the data message 1240.

The link controller 116A, responsive to receiving the data message 1240, extracts the data 1042 from the data message 1240 and writes the data 1042 at a first location of the memory 340. The link controller 116A, subsequent to writing the data 1042 to the memory 340, issues an interrupt 1362 to the interface controller 114A. In a particular aspect, the interface controller 114A, responsive to the interrupt 1362 and based on determining that the interrupt 1362 is associated with the device identifier 562 of the device 164AA and that the configuration data 130 indicates that the application 502A is registered to be notified of interrupts associated with the device 164AA or a device type (e.g., a display device type) of the device 164AA, provides the interrupt 1362 to the II 514AA associated with the application 502A.

The II 514AA, responsive to the interrupt 1362, generates a TRE 1334 that includes the I/O status 1036. For example, the II 514AA generates the TRE 1334 (e.g., a completion TRE) based on the TRE 934 generated responsive to the read message 932 from the application 502A, as described with reference to FIG. 9, based on the received I/O status 1036 of the read transaction 1018, as described with reference to FIG. 11A, or both. The II 514AA writes the TRE 1334 to the memory 340 and issues an interrupt 1364 to the II 504A. The II 504A, responsive to the interrupt 1364, retrieves the I/O status 1036, the data 1042, or both, from the memory 340, and provides the I/O status 1036, the data 1042, or both, to the application 502A.

A technical advantage of having the II 514AA send the read command 1140, as described with reference to FIG. 11B, includes reduced latency associated with the data read, as compared to the application 502A being notified that the read operation is complete at the device 164AA and the application 502A initiating a read request at the II 514AA.

Referring to FIG. 14, an example 1400 is depicted of message formats of messages exchanged during a host-initiated read described with reference to FIGS. 9-13, in accordance with some examples of the present disclosure. For example, a read request format 1450 can correspond to a format of the read request 940 of FIG. 9. As another example, the interrupt message format 854 can correspond to a format of the interrupt message 1026 of FIG. 10B. In some examples, a data message format 1454 can correspond to a format of the data message 1240 of FIG. 12B.

The read request format 1450 includes a plurality of fields. For example, the read request format 1450 includes a data EP identifier field 1402 and header fields 1404. In a particular aspect, the read request 940 of FIG. 9 includes the data EP identifier 564 of the data EP 156A in the data EP identifier field 1402. The header fields 1404 include values that are based on a communication protocol of the data EP 156A, as further described with reference to FIGS. 17-20. In a particular aspect, the read request 940 includes the device identifier 562 in at least a portion of the header fields 1404. In a particular aspect, the header fields 1404 have a pre-determined length (e.g., 8 bytes) that is communication protocol-independent.

In a particular aspect, the interrupt message 1026 of FIG. 10B includes the interrupt EP identifier 638 of the interrupt EP 256 in the interrupt EP identifier field 812, the data EP identifier 564 in the data EP identifier field 814, and the I/O status 1036 in at least a portion of the payload fields 816. In a particular aspect, the interrupt message 1026 includes the device identifier 562 in at least a portion of the payload fields 816.

The data message format 1454 includes a plurality of fields. For example, the data message format 1454 includes a data EP identifier field 1412 and data fields 1414. In a particular aspect, the data message 1240 of FIG. 12B includes the data EP identifier 564 of the data EP 156A in the data EP identifier field 1412, and the data 1042 in the data fields 1414. In a particular aspect, the data message 1240 includes the device identifier 562 in at least a portion of the data fields 1414.

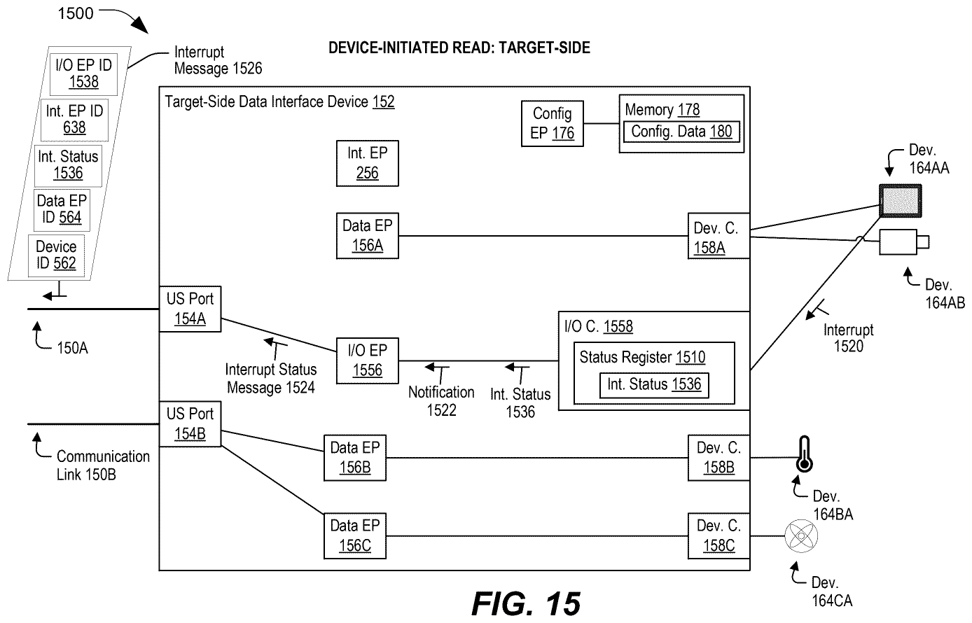

Referring to FIG. 15, an illustrative example 1500 is depicted of operations at the target-side data interface device 152 that are associated with a device-initiated read, in accordance with some examples of the present disclosure. In an illustrative aspect, a device-initiated read corresponds to a device 164 that has data available to send to the host-side data interface device 102, independently of any read request from the host-side data interface device 102.

The target-side data interface device 152 includes an I/O EP 1556 coupled to an I/O controller 1558. The I/O controller 1558 includes a status register 1510 and is configured to detect interrupts from one or more devices 164.

Optionally, in some implementations, the target-side data interface device 152 can include multiple I/O controllers 1558 configured to detect interrupts. For example, a first I/O controller 1558 can be configured to detect interrupts from a first subset of the devices 164, and a second I/O controller 1558 can be configured to detect interrupts from a second subset of the devices 164.

The I/O controller 1558 receives an interrupt 1520 (e.g., an interrupt indication) from the device 164AA. In an illustrative example, the device 164AA includes a touchscreen device and generates the interrupt 1520 responsive to detection of user input via the touchscreen device. In some aspects, the interrupt 1520 includes an interrupt status 1536. The I/O controller 1558, in response to detecting the interrupt 1520, stores the interrupt status 1536 associated with the interrupt 1520 in the status register 1510, and sends a notification 1522 to the I/O EP 1556. The I/O EP 1556, responsive to the notification 1522, retrieves the interrupt status 1536 from the status register 1510 of the I/O controller 1558 and generates an interrupt status message 1524.

The interrupt status message 1524 includes the interrupt status 1536. In some examples, the interrupt status message 1524 also includes the device identifier 562 of the device 164AA that issued the interrupt 1520, an I/O EP identifier 1538 of the I/O EP 1556, or both. In a particular aspect, the I/O EP 1556, based on determining that the interrupt status 1536 is received from the device 164AA and that the configuration data 180 indicates that the device 164AA is coupled to the device controller 158A that is coupled to the data EP 156A, generates the interrupt status message 1524 including the data EP identifier 564 of the data EP 156A.

The I/O EP 1556 send the interrupt status message 1524 to the upstream port 154A. In a particular aspect, the I/O EP 1556, based on determining that the interrupt status 1536 is received from the device 164AA and that the configuration data 180 indicates that the device 164AA is coupled to the device controller 158A that is coupled to the data EP 156A and that the upstream port 154A is assigned to the data EP 156A, provides the interrupt status message 1524 to the upstream port 154A to generate an interrupt message 1526.

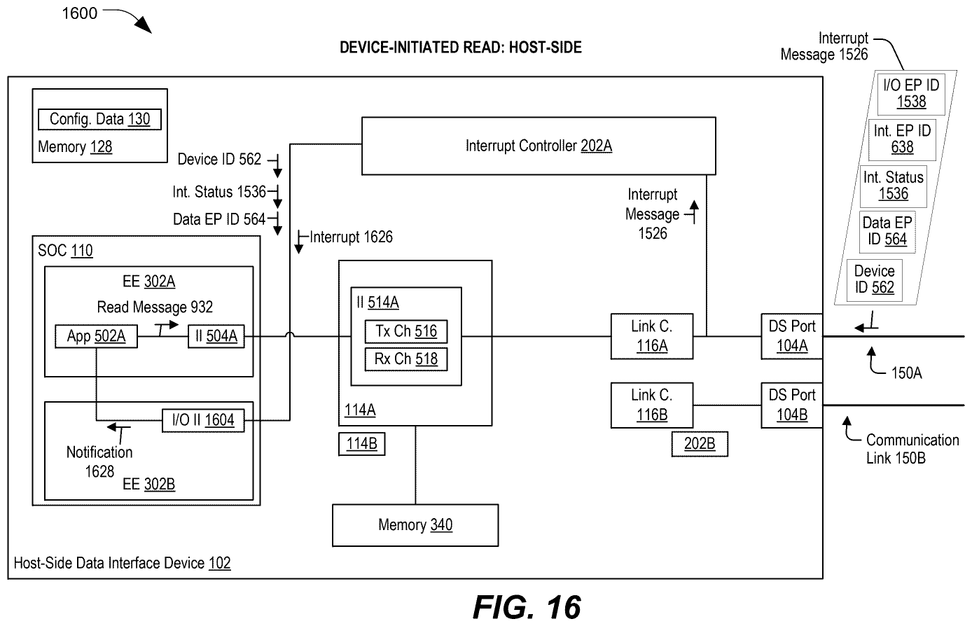

The upstream port 154A, responsive to the interrupt status message 1524, generates the interrupt message 1526 including the I/O EP identifier 1538, the interrupt status 1536, the data EP identifier 564, the device identifier 562, or a combination thereof. The upstream port 154A generates the interrupt message 1526 to include a pre-determined value (e.g., the interrupt EP identifier 638 of the interrupt EP 256) that identifies the interrupt message 1526 as being of an interrupt message type that is to be processed by an interrupt controller 202 of the host-side data interface device 102. For example, the interrupt message 1526 is generated to include the pre-determined value (e.g., the interrupt EP identifier 638) to cause the interrupt controller 202A of the host-side data interface device 102 to process the interrupt message 1526. The interrupt message 1526 is generated to include the I/O EP identifier 1538, in addition to the interrupt EP identifier 638, to cause the interrupt controller 202A to provide the interrupt status 1536 to an I/O II associated with the I/O controller 1558 (and not to the interface controller 114A), as further described with reference to FIG. 16. The upstream port 154A sends the interrupt message 1526 via the communication link 150A to the host-side data interface device 102.

Referring to FIG. 16, an illustrative example 1600 is depicted of operations at the host-side data interface device 102 that are associated with the device-initiated read, in accordance with some examples of the present disclosure. An execution environment 302A of the SOC 110 includes the application 502A that, during a configuration phase, registered to receive notification corresponding to interrupts from the device 164AA or from devices of the same device type as the device 164AA, as described with reference to FIG. 3.

An execution environment 302B includes an I/O II 1604 that is associated with the I/O controller 1558 of the target-side data interface device 152. For example, each of the plurality of interrupt controllers 202 is configured to, based on receiving an interrupt message indicating the interrupt EP identifier 638, and the I/O EP identifier 1538, issue an interrupt to the I/O II 1604 associated with the I/O controller 1558. It should be understood that the I/O II 1604 included in the execution environment 302B that is distinct from the execution environment 302A that includes the application 502A is provided as an illustrative example. In some other examples, the application 502A can be included in the same execution environment 302 as the I/O II 1604. To illustrate, the I/O II 1604 can communicate with one or more applications in the same execution environment, one or more applications in one or more other execution environments, or a combination thereof.

The downstream port 104A receives the interrupt message 1526 via the communication link 150A and outputs the interrupt message 1526. The interrupt controller 202A detects the interrupt message 1526 output by the downstream port 104A. The interrupt controller 202A selectively, based on determining whether the interrupt message 1526 includes the pre-determined value (e.g., the interrupt EP identifier 638), processes the interrupt message 1526. For example, the interrupt controller 202A, based on determining that the interrupt message 1526 includes the pre-determined value and the I/O EP identifier 1538 and determining that the configuration data 130 indicates that the I/O EP 1556 having the I/O EP identifier 1538 is coupled to the I/O controller 1558 and that the I/O II 1604 is associated with the I/O controller 1558, issues an interrupt 1626 to the I/O II 1604.

The I/O II 1604, responsive to the interrupt 1626, obtains a payload of the interrupt message 1526 from the interrupt controller 202A. For example, the I/O II 1604 obtains the interrupt status 1536, the device identifier 562, the data EP identifier 564, or a combination thereof, from the interrupt controller 202A. The I/O II 1604, based on determining that the interrupt status 1536 is associated with the device 164AA having the device identifier 562 and that the configuration data 130 indicates that the application 502A is registered to receiving notifications regarding interrupts from the device 164AA or devices of the same device type as the device 164AA, provides notification 1628 indicating the interrupt status 1536 to the application 502A. The application 502A, based on the interrupt status 1536, initiates one or more interrupt handling operations at the application 502A. For example, the application 502A, based on determining that the interrupt status 1536 corresponds to a device-initiated read from the device 164AA, generates the read message 932 indicating the device identifier 562 of the device 164AA. The application 502A sends the read message 932 to the II 504A to initiate read operations similar to the host-initiated read, described with reference to FIGS. 9-13.

Optionally, in some implementations, the interrupt message format 854 of FIG. 8 corresponds to a format of the interrupt message 1526. In a particular aspect, the interrupt message 1526 includes the interrupt EP identifier 638 of the interrupt EP 256 in the interrupt EP identifier field 812, and the data EP identifier 564 in the data EP identifier field 814. In a particular aspect, the interrupt message 1526 includes the interrupt status 1536, the I/O EP identifier 1538, the device identifier 562, or a combination thereof, in respective portions of the payload fields 816.

Referring to FIG. 17, an example 1700 is depicted of a header format of an inter-integrated circuit (I2C) input/output (I/O) request, designated as “I2C I/O request header format 1750” in FIG. 17, in accordance with some examples of the present disclosure.

The I2C I/O request header format 1750 has a pre-determined length (e.g., 8 bytes) that is independent of the I2C communication protocol. The I2C I/O request header format 1750 includes a command opcode field 1702 (e.g., bits 0-4 of byte 0), a controller code field 1704 (e.g., bits 5-7 of byte 0), a target identifier field 1706 (e.g., bits 0-6 of byte 1), a flags field 1708 (e.g., bit 7 of byte 1 to bit 1 of byte 2), and a length field 1710 (e.g., bytes 4-6). The remaining bits of the I2C I/O request header format 1750 are reserved.

In a particular aspect, the header fields 804 of the write request format 850 correspond to the I2C I/O request header format 1750. For example, the II 514AA, based on determining that the data EP 156A uses an I2C communication protocol, generates the write request 540 of FIG. 5 including a header that complies with the I2C I/O request header format 1750.

In a particular aspect, the header fields 1404 of the read request format 1450 correspond to the I2C I/O request header format 1750. For example, the II 514AA, based on determining that the data EP 156A uses an I2C communication protocol, generates the read request 940 of FIG. 9 including a header that complies with the I2C I/O request header format 1750.

An example 1760 is shown of values of the command opcode field 1702. An example 1762 is shown of values of the flags field 1708. In an example, the target identifier field 1706 is used to store a device identifier of a device 164 (e.g., the device 164AA in the write request 540 or the read request 940) that is a target (e.g., a destination) of an I/O request that includes a header in compliance with the I2C I/O request header format 1750. In an example, the length field 1710 indicates a length of the data fields 806 following a header of a write request 540 that complies with the I2C I/O request header format 1750.

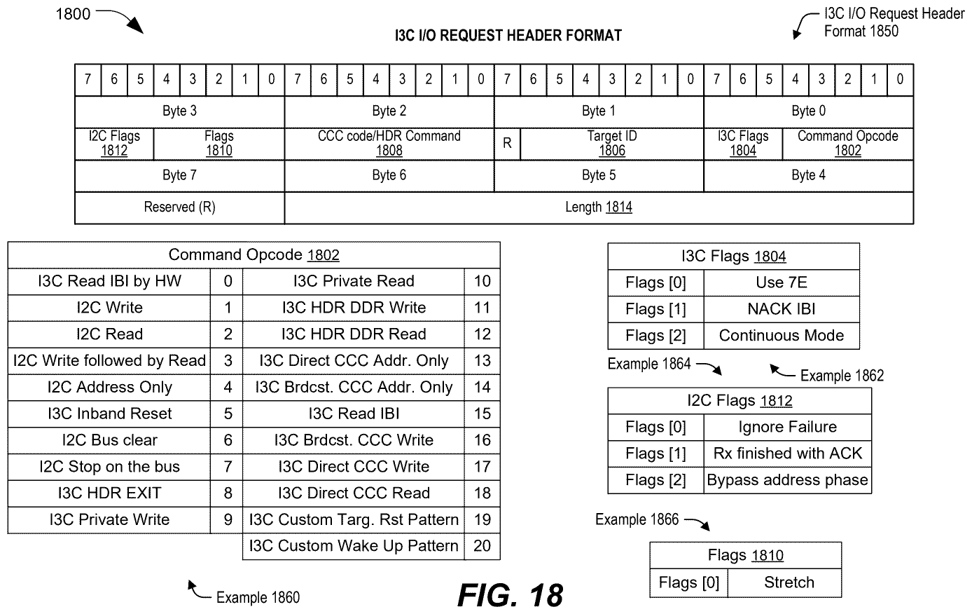

Referring to FIG. 18, an example 1800 is depicted of a header format of an improved inter-integrated circuit (I3C) I/O request, designated as “I3C I/O request header format 1850” in FIG. 18, in accordance with some examples of the present disclosure.

The I3C I/O request header format 1850 has a pre-determined length (e.g., 8 bytes) that is independent of the I3C communication protocol. The I3C I/O request header format 1850 includes a command opcode field 1802 (e.g., bits 0-4 of byte 0), an I3C flags field 1804 (e.g., bits 5-7 of byte 0), a target identifier field 1806 (e.g., bits 0-6 of byte 1), a common command codes (CCC) code/high data rate (HDR) command field 1808 (e.g., byte 2), a flags field 1810 (e.g., bits 0-4 of byte 3), an I2C flags field 1812 (e.g., bits 5-7 of byte 3), and a length field 1814 (e.g., bytes 4-6). The remaining bits of the I3C I/O request header format 1850 are reserved.

In a particular aspect, the header fields 804 of the write request format 850 correspond to the I3C I/O request header format 1850. For example, the II 514AA, based on determining that the data EP 156A uses an I3C communication protocol, generates the write request 540 of FIG. 5 including a header that complies with the I3C I/O request header format 1850.

In a particular aspect, the header fields 1404 of the read request format 1450 correspond to the I3C I/O request header format 1850. For example, the II 514AA, based on determining that the data EP 156A uses an I3C communication protocol, generates the read request 940 of FIG. 9 including a header that complies with the I3C I/O request header format 1850.

An example 1860 is shown of values of the command opcode field 1802. An example 1862 is shown of values of the I 3C flags field 1804. An example 1864 is shown of values of the I2C flags field 1812. An example 1866 is shown of values of the flags field 1810.

In an example, the target identifier field 1806 is used to store a device identifier of a device 164 (e.g., the device 164AA in the write request 540 or the read request 940). In an example, the length field 1814 indicates a length of the data fields 806 following a header of a write request 540 that complies with the I3C I/O request header format 1850.

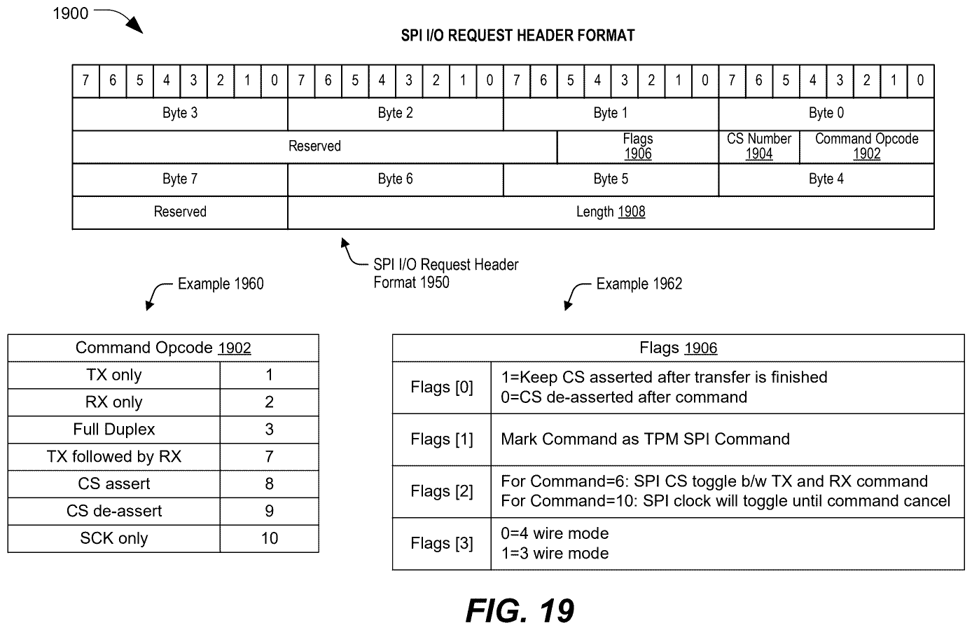

Referring to FIG. 19, an example 1900 is depicted of a header format of a serial peripheral interface (SPI) I/O request, designated as “SPI I/O request header format 1950” in FIG. 19, in accordance with some examples of the present disclosure.

The SPI I/O request header format 1950 has a pre-determined length (e.g., 8 bytes) that is independent of the SPI I/O communication protocol. The SPI I/O request header format 1950 includes a command opcode field 1902 (e.g., bits 0-4 of byte 0), a chip select (CS) number field 1904 (e.g., bits 5-7 of byte 0), a flags field 1906 (e.g., bits 0-5 of byte 1), and a length field 1908 (e.g., bytes 4-6). The remaining bits of the SPI I/O request header format 1950 are reserved.

In a particular aspect, the header fields 804 of the write request format 850 correspond to the SPI I/O request header format 1950. For example, the II 514AA, based on determining that the data EP 156A uses an SPI communication protocol, generates the write request 540 of FIG. 5 including a header that complies with the SPI I/O request header format 1950.

In a particular aspect, the header fields 1404 of the read request format 1450 correspond to the SPI I/O request header format 1950. For example, the II 514AA, based on determining that the data EP 156A uses an SPI communication protocol, generates the read request 940 of FIG. 9 including a header that complies with the SPI I/O request header format 1950.

An example 1960 is shown of values of the command opcode field 1902. An example 1962 is shown of values of the flags field 1906. In an example, the CS number field 1904 indicates an active chip-select number. In an example, the length field 1908 indicates a length of transaction. In an illustrative implementation, the length of transaction indicates a length of the data fields 806 following a header of a write request 540 that complies with the SPI I/O request header format 1950.

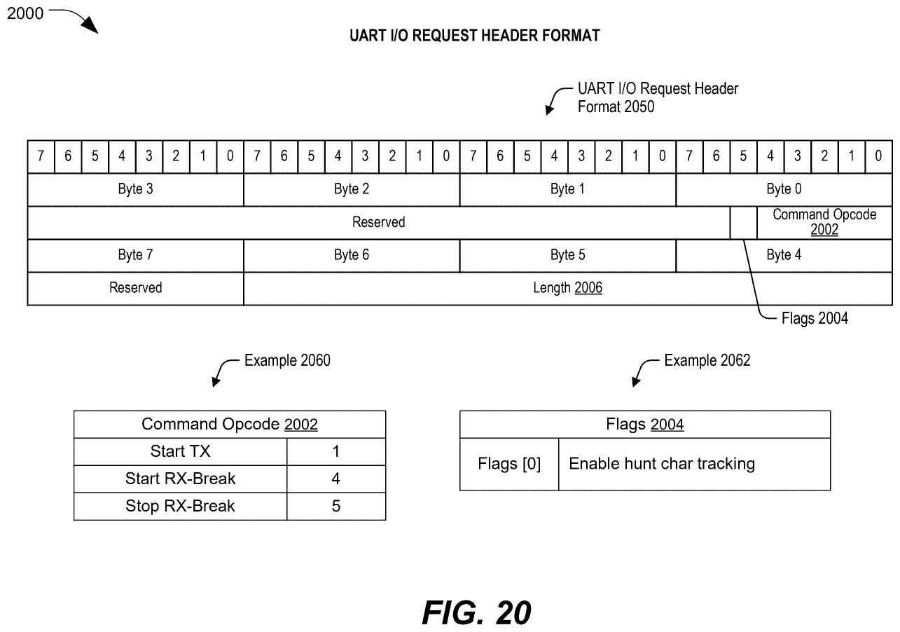

Referring to FIG. 20, an example 2000 is depicted of a header format of a universal asynchronous receiver-transmitter (UART) I/O request, designated as “UART I/O request header format 2050” in FIG. 20, in accordance with some examples of the present disclosure.

The UART I/O request header format 2050 has a pre-determined length (e.g., 8 bytes) that is independent of the UART I/O communication protocol. The UART I/O request header format 2050 includes a command opcode field 2002 (e.g., bits 0-4 of byte 0), a flags field 2004 (e.g., bit 5 of byte 0), and a length field 2006 (e.g., bytes 4-6). The remaining bits of the UART I/O request header format 2050 are reserved.

In a particular aspect, the header fields 804 of the write request format 850 correspond to the UART I/O request header format 2050. For example, the II 514AA, based on determining that the data EP 156A uses a UART communication protocol, generates the write request 540 of FIG. 5 including a header that complies with the UART I/O request header format 2050.

In a particular aspect, the header fields 1404 of the read request format 1450 correspond to the UART I/O request header format 2050. For example, the II 514AA, based on determining that the data EP 156A uses a UART communication protocol, generates the read request 940 of FIG. 9 including a header that complies with the UART I/O request header format 2050.

An example 2060 is shown of values of the command opcode field 2002. An example 2062 is shown of values of the flags field 2004. In an example, the length field 2008 indicates a length of transaction. In an illustrative implementation, the length of transaction indicates a length of the data fields 806 following a header of a write request 540 that complies with the UART I/O request header format 2050.

FIG. 21 depicts an implementation 2100 in which the system 100 of FIG. 1, the system 200 of FIG. 2, the system 300 of FIG. 3, or a combination thereof, include a mobile device 2102, such as a flip phone, as an illustrative, non-limiting example. The mobile device 2102 includes a host-side 2150 coupled with a hinge 2154 to a target-side 2152.

The host-side data interface device 102 is integrated in the host-side 2150 and the target-side data interface device 152 is integrated in the target-side 2152. The host-side data interface device 102 and the target-side data interface device 152 are illustrated using dashed lines to indicate internal components that are not generally visible to a user of the mobile device 2102.

The mobile device 2102 includes a display screen 2104 and a loudspeaker 2120. In a particular aspect, the display screen 2104 and the loudspeaker 2120 correspond to one or more of the devices 164 of FIG. 1. The mobile device 2102 can include one or more additional devices 164, such as a camera, a gyroscope, a temperature sensor, an accelerometer, or a combination thereof. In a particular example, the host-side data interface device 102 and the target-side data interface device 152 perform one or more operations described with reference to FIGS. 1-20 to enable communication between the host-side data interface device 102 and the target-side data interface device 152 of the mobile device 2102.

FIG. 22 depicts an implementation 2200 in which the system 100 of FIG. 1, the system 200 of FIG. 2, the system 300 of FIG. 3, or a combination thereof, include a mobile device 2202, such as a foldable phone or a foldable tablet, as illustrative, non-limiting examples. The mobile device 2202 includes a host-side 2250 coupled with a hinge 2254 to a target-side 2252.

The host-side data interface device 102 is integrated in the host-side 2250 and the target-side data interface device 152 is integrated in the target-side 2252. The host-side data interface device 102 and the target-side data interface device 152 are illustrated using dashed lines to indicate internal components that are not generally visible to a user of the mobile device 2202.

The mobile device 2202 includes a display screen 2204, a microphone 2222, and a camera 2220. In a particular aspect, the display screen 2204, the microphone 2222, and the camera 2220 correspond to one or more of the devices 164 of FIG. 1. The mobile device 2202 can include one or more additional devices 164, such as a loudspeaker, a gyroscope, a temperature sensor, an accelerometer, or a combination thereof. In a particular example, the host-side data interface device 102 and the target-side data interface device 152 perform one or more operations described with reference to FIGS. 1-20 to enable communication between the host-side data interface device 102 and the target-side data interface device 152 of the mobile device 2202.

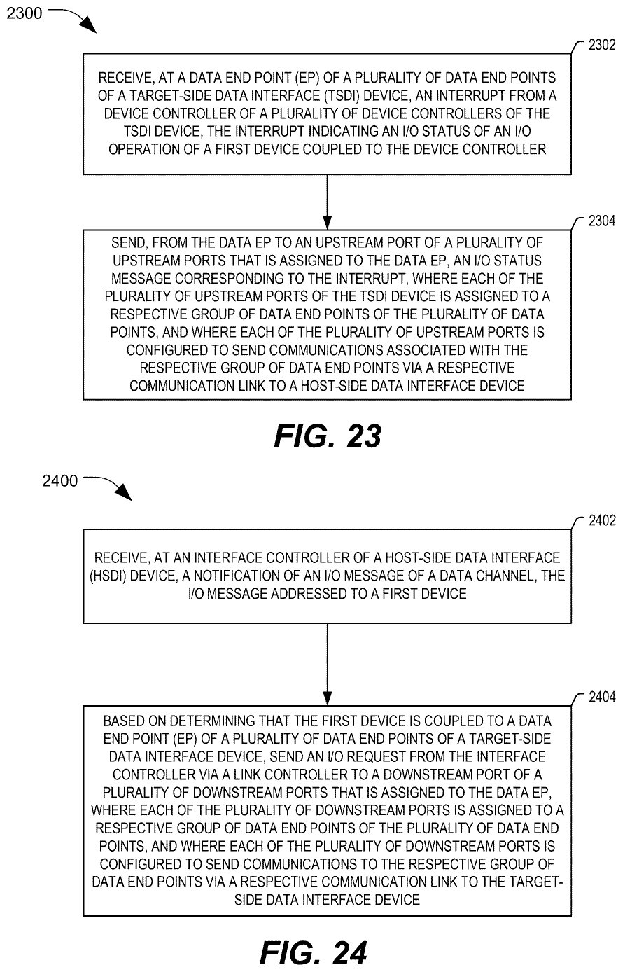

Referring to FIG. 23, a particular implementation of a method 2300 of communication between a target-side data interface device and a host-side data interface device is shown. In a particular aspect, one or more operations of the method 2300 are performed by at least one of a data end point 156, a target-side data interface device 152, a system 100 of FIG. 1, the system 200 of FIG. 2, the system 300 of FIG. 3, or a combination thereof.

The method 2300 includes, at 2302, receiving, at a data end point (EP) of a plurality of data end points of a target-side data interface device, an interrupt from a device controller of a plurality of device controllers of the target-side data interface device, the interrupt indicating an I/O status of an I/O operation of a first device coupled to the device controller. For example, the data EP 156A receives the interrupt 622 from the device controller 158A of the target-side data interface device 152, the interrupt 622 indicates the I/O status 636 of an I/O operation corresponding to the write transaction 618 at the device 164AA coupled to the device controller 158A, as described with reference to FIGS. 6A-6B. In another example, the data EP 156A receives the interrupt 1022 from the device controller 158A of the target-side data interface device 152, the interrupt 1022 indicates the I/O status 1036 of an I/O operation corresponding to the read transaction 1018 at the device 164AA coupled to the device controller 158A, as described with reference to FIGS. 10A-10B.

The method 2300 includes, at 2304, sending, from the data EP to an upstream port of a plurality of upstream ports that is assigned to the data EO, an I/O status message corresponding to the interrupt, where each of the plurality of upstream ports of the target-side data interface device is assigned to a respective group of data end points of the plurality of data points, and where each of the plurality of upstream ports is configured to send communications associated with the respective group of data end points via a respective communication link to a host-side data interface device. For example, the data EP 156A sends, to the upstream port 154A that is assigned to the data EP 156A, the I/O status message 624 corresponding to the interrupt 622, as described with reference to FIG. 6B. In another example, the data EP 156A sends, to the upstream port 154A assigned to the data EP 156A, the I/O status message 1024 corresponding to the interrupt 1022, as described with reference to FIG. 10B. Each of the plurality of upstream ports 154 is assigned to a respective group of data end points 156, and each of the plurality of upstream ports 154 is configured to send communications associated with the respective group of data end points 156 via a respective communication link 150 to the host-side data interface device 102.

A technical advantage of the method 2300 includes aggregating communications from a group of devices into a corresponding communication link, thereby enabling a reduction in the number of communication links between the host-side data interface device and the target-side data interface device, as compared to a dedicated communication link per device to the host-side data interface device. In some examples, reducing the number of communication links between the host-side data interface device and the target-side data interface device can result in less bulky flex cables between the host-side data interface device and the target-side data interface device, and a sleeker foldable device.

The method 2300 of FIG. 23 may be implemented by a field-programmable gate array (FPGA) device, an application-specific integrated circuit (ASIC), a processing unit, a controller, another hardware device, firmware device, or any combination thereof. As an example, the method 2300 of FIG. 23 may be performed by a processor that executes instructions, such as described with reference to FIG. 26.

Referring to FIG. 24, a particular implementation of a method 2400 of communication between a target-side data interface device and a host-side data interface device is shown. In a particular aspect, one or more operations of the method 2400 are performed by at least one of a data end point 156, a target-side data interface device 152, a system 100 of FIG. 1, the system 200 of FIG. 2, the method 300 of FIG. 3, or a combination thereof.

The method 2400 includes, at 2402, receiving, at an interface controller of a host-side data interface device, a notification of an I/O message of a data channel, the I/O message addressed to a first device. For example, the II 514AA of the host-side data interface device 102 receives the notification 538 of the write message 532 of a transmit data channel 516AA, as described with reference to FIG. 5. The write message 532 is addressed to the device 164AA. As another example, the II 514AA of the host-side data interface device 102 receives the notification 938 of the read message 932 of a receive data channel 518AA, as described with reference to FIG. 9. The read message 932 is addressed to the device 164AA.

The method 2400 includes, at 2404, based on determining that the first device is coupled to a data end point (EP) of a plurality of data end points of a target-side data interface device, sending an I/O request from the interface controller via a link controller to a downstream port of a plurality of downstream ports that is assigned to the data EP, where each of the plurality of downstream ports is assigned to a respective group of data end points of the plurality of data end points, and where each of the plurality of downstream ports is configured to send communications to the respective group of data end points via a respective communication link to the target-side data interface device. For example, the II 514AA, based on determining that the device 164AA is coupled to the data EP 156A of the target-side data interface device 152, sends the write request 540 via the link controller 116A to the downstream port 104A that is assigned to the data EP 156A, as described with reference to FIG. 5. As another example, the II 514AA, based on determining that the device 164AA is coupled to the data EP 156A of the target-side data interface device 152, sends the read request 940 via the link controller 116A to the downstream port 104A that is assigned to the data EP 156A, as described with reference to FIG. 9. Each of the downstream ports 104 is assigned to a respective group of data end points 156, and each of the downstream ports 104 is configured to send communications to the respective group of data end points 156 via a respective communication link 150 to the target-side data interface device 152.

A technical advantage of the method 2400 includes aggregating communications to a group of devices into a corresponding communication link, thereby enabling a reduction in the number of communication links between the host-side data interface device and the target-side data interface device, as compared to a dedicated communication link per device to the host-side data interface device. In some examples, reducing the number of communication links between the host-side data interface device and the target-side data interface device can result in less bulky flex cables between the host-side data interface device and the target-side data interface device, and a sleeker foldable device.

The method 2400 of FIG. 24 may be implemented by a FPGA device, an ASIC, a processing unit, a controller, another hardware device, firmware device, or any combination thereof. As an example, the method 2400 of FIG. 24 may be performed by a processor that executes instructions, such as described with reference to FIG. 26.

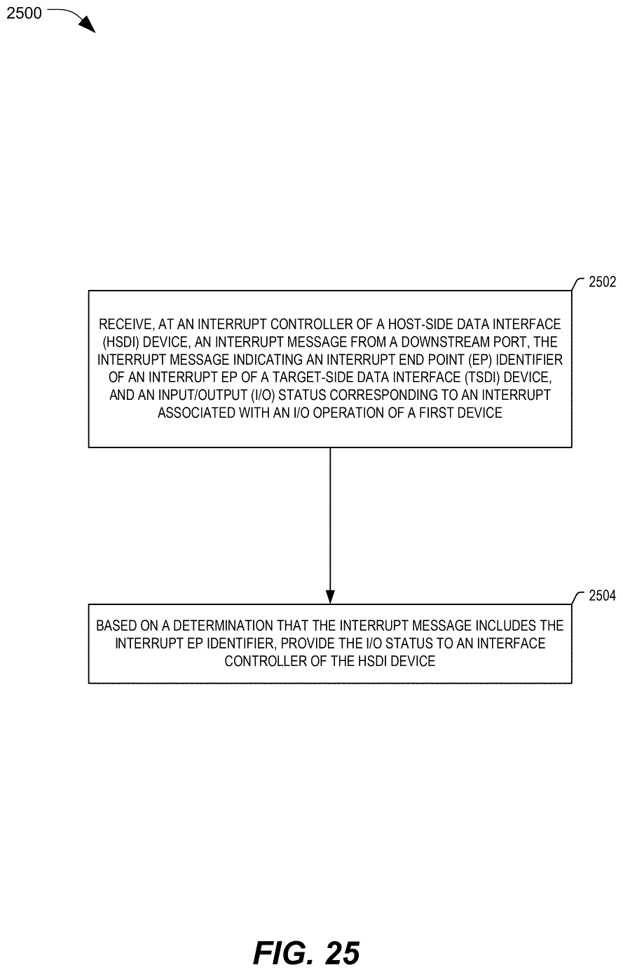

Referring to FIG. 25, a particular implementation of a method 2500 of communication between a target-side data interface device and a host-side data interface device is shown. In a particular aspect, one or more operations of the method 2500 are performed by at least one of a data end point 156, a target-side data interface device 152, a system 100 of FIG. 1, the system 200 of FIG. 2, the system 300 of FIG. 3, or a combination thereof.

The method 2500 includes, at 2502, receiving, at an interrupt controller of a host-side data interface device, an interrupt message from a downstream port, the interrupt message indicating an interrupt end point (EP) identifier of an interrupt EP of a target-side data interface device, and an input/output (I/O) status corresponding to an interrupt associated with an I/O operation of a first device. For example, the interrupt controller 202A of the host-side data interface device 102 receives the interrupt message 626 from the downstream port 104A, as described with reference to FIG. 7. The interrupt message 626 indicates the interrupt EP identifier 638 of the interrupt EP 256 of the target-side data interface device 152 and the I/O status 636 corresponding to the interrupt 622 associated with an I/O operation of the device 164AA.

Another example, the interrupt controller 202A of the host-side data interface device 102 receives the interrupt message 1026 from the downstream port 104A, as described with reference to FIG. 11A. The interrupt message 1026 indicates the interrupt EP identifier 638 of the interrupt EP 256 of the target-side data interface device 152 and the I/O status 1036 corresponding to the interrupt 1022 associated with an I/O operation of the device 164AA.

The method 2500 includes, at 2504, based on a determination that the interrupt message includes the interrupt EP identifier, providing the I/O status to an interface controller of the host-side data interface device. For example, the interrupt controller 202A, based on a determination that the interrupt message 626 includes the interrupt EP identifier 638, provides the I/O status 636 to the II 514AA of the host-side data interface device 102, as described with reference to FIG. 7. As another example, the interrupt controller 202A, based on a determination that the interrupt message 1026 includes the interrupt EP identifier 638, provides the I/O status 1036 to the II 514AA of the host-side data interface device 102, as described with reference to FIG. 11A.

A technical advantage of the method 1500 includes enabling the II 514AA to perform one or more operations based on the I/O status 1036 without the latency associated with informing the application 502A and having the application 502A causing the II 514AA to initiate the same operations. For example, the II 514AA can send a read command 1140 based on the I/O status 1036 to retrieve data buffered at the target-side data interface device 152, as described with reference to FIG. 11B.

The method 2500 of FIG. 25 may be implemented by a FPGA device, an ASIC, a processing unit, a controller, another hardware device, firmware device, or any combination thereof. As an example, the method 2500 of FIG. 25 may be performed by a processor that executes instructions, such as described with reference to FIG. 26.

Referring to FIG. 26, a block diagram of a particular illustrative implementation of a device is depicted and generally designated 2600. In various implementations, the device 2600 may have more or fewer components than illustrated in FIG. 26. In an illustrative implementation, the device 2600 may correspond to the system 100 of FIG. 1, the system 200 of FIG. 2, the system 300 of FIG. 3, the mobile device 2100 of FIG. 21, the mobile device 2200 of FIG. 22, or a combination thereof. In an illustrative implementation, the device 2600 may perform one or more operations described with reference to FIGS. 1-25.

In a particular implementation, the device 2600 includes a processor 2606 (e.g., a central processing unit (CPU)). The device 2600 may include one or more additional processors 2610 (e.g., one or more digital signal processors (DSPs)). The processors 2610 may include a speech and music coder-decoder (CODEC) 2608 that includes a voice coder (“vocoder”) encoder 2636, a vocoder decoder 2638, or both.

In a particular aspect, the host-side data interface device 102 is integrated into a host-side of the device 2600 and the target-side data interface device 152 is integrated into a target-side of the device 1600. In a particular aspect, the SOC 110 of the host-side data interface device 102 includes the processor 2606, the processors 2610, or a combination thereof.

The device 2600 may include a memory 2686 and a CODEC 2634. The memory 2686 may include instructions 2656, that are executable by the host-side data interface device 102, the target-side data interface device 152, or both, to implement the functionality described with reference to FIGS. 1-25. In a particular aspect, the memory 2686 includes data used or generated by the host-side data interface device 102, the target-side data interface device 152, or a combination thereof. The device 2600 may include a modem 2670 coupled, via a transceiver 2650, to an antenna 2652.

The device 2600 may include a display 2628 coupled to a display controller 2626. One or more speakers 2692, one or more microphone 2690, or a combination thereof may be coupled to the CODEC 2634. The CODEC 2634 may include a digital-to-analog converter (DAC) 2602, an analog-to-digital converter (ADC) 2604, or both. In a particular implementation, the CODEC 2634 may receive analog signals from the one or more microphones 2690, convert the analog signals to digital signals using the analog-to-digital converter 2604, and provide the digital signals to the speech and music codec 2608. The speech and music codec 2608 may process the digital signals. In a particular implementation, the speech and music codec 2608 may provide digital signals to the CODEC 2634. The CODEC 2634 may convert the digital signals to analog signals using the digital-to-analog converter 2602 and may provide the analog signals to the one or more speakers 2692.

In a particular implementation, the device 2600 may be included in a system-in-package or system-on-chip device 2622. In a particular implementation, the memory 2686, the processor 2606, the processors 2610, the display controller 2626, the CODEC 2634, and the modem 2670 are included in the system-in-package or system-on-chip device 2622. In a particular aspect, the system-in-package or system-on-chip device 2622 includes the SOC 110 of the host-side data interface device 102.

In a particular implementation, an input device 2630 and a power supply 2644 are coupled to the system-in-package or the system-on-chip device 2622. Moreover, in a particular implementation, as illustrated in FIG. 26, the display 2628, the input device 2630, the one or more speakers 2692, the one or more microphones 2690, the antenna 2652, and the power supply 2644 are external to the system-in-package or the system-on-chip device 2622. In a particular implementation, each of the display 2628, the input device 2630, the one or more speakers 2692, the one or more microphones 2690, the antenna 2652, and the power supply 2644 may be coupled to a component of the system-in-package or the system-on-chip device 2622, such as an interface or a controller. In a particular aspect, the devices 164 of FIG. 1 may include one or more of the display 2628, the input device 2630, the one or more speakers 2692, the one or more microphones 2690, the antenna 2652, or the power supply 2644.

The device 2600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for receiving, at a data end point (EP) of a plurality of data end points of a target-side data interface device, an interrupt from a device controller of a plurality of device controllers of the target-side data interface device, the interrupt indicating an I/O status of an I/O operation of a first device coupled to the device controller. For example, the means for receiving can correspond to a data EP 156, the target-side data interface device 152, the system 100 of FIG. 1, the system 200 of FIG. 2, the system 300 of FIG. 3, the device 2600 of FIG. 26, one or more other circuits or components configured to receive the interrupt from the device controller, or any combination thereof.

The apparatus also includes means for sending, from the data EP to an upstream port of a plurality of upstream ports that is assigned to the data EO, an I/O status message corresponding to the interrupt, where each of the plurality of upstream ports of the target-side data interface device is assigned to a respective group of data end points of the plurality of data points, and where each of the plurality of upstream ports is configured to send communications associated with the respective group of data end points via a respective communication link to a host-side data interface device. For example, the means for sending can correspond to a data EP 156, the target-side data interface device 152, the system 100 of FIG. 1, the system 200 of FIG. 2, the system 300 of FIG. 3, the device 2600 of FIG. 26, one or more other circuits or components configured to send the I/O status to an assigned upstream port, or any combination thereof.

Also, in conjunction with the described implementations, an apparatus includes means for receiving, at an interface controller of a host-side data interface device, a notification of an I/O message of a data channel, the I/O message addressed to a first device. For example, the means for receiving can correspond to an interface controller 114, the host-side data interface device 102, the system 100 of FIG. 1, the system 200 of FIG. 2, the system 300 of FIG. 3, the device 2600 of FIG. 26, one or more other circuits or components configured to receive the notification of an I/O message, or any combination thereof.

The apparatus also includes means for sending, based on determining that the first device is coupled to a data end point (EP) of a plurality of data end points of a target-side data interface device, an I/O request from the interface controller via a link controller to a downstream port of a plurality of downstream ports that is assigned to the data EP, where each of the plurality of downstream ports is assigned to a respective group of data end points of the plurality of data end points, and where each of the plurality of downstream ports is configured to send communications to the respective group of data end points via a respective communication link to the target-side data interface device. For example, the means for sending can correspond to an interface controller 114, the host-side data interface device 102, the system 100 of FIG. 1, the system 200 of FIG. 2, the system 300 of FIG. 3, the device 2600 of FIG. 26, one or more other circuits or components configured to send the I/O request, or any combination thereof.

Further, in conjunction with the described implementations, an apparatus includes means for receiving, at an interrupt controller of a host-side data interface (HSDI) device, an interrupt message from a downstream port, the interrupt message indicating an interrupt end point (EP) identifier of an interrupt ep of a target-side data interface (TSDI) device, and an input/output (I/O) status corresponding to an interrupt associated with an I/O operation of a first device. For example, the means for receiving can correspond to the host-side data interface device 102, the system 100 of FIG. 1, an interrupt controller 202, the system 200 of FIG. 2, the system 300 of FIG. 3, the device 2600 of FIG. 26, one or more other circuits or components configured to receive the interrupt message, or any combination thereof.

The apparatus also includes means for providing, based on a determination that the interrupt message includes the interrupt ep identifier, the I/O status to an interface controller of the HSDI device. For example, the means for providing can correspond to the host-side data interface device 102, the system 100 of FIG. 1, an interrupt controller 202, the system 200 of FIG. 2, the system 300 of FIG. 3, the device 2600 of FIG. 26, one or more other circuits or components configured to receive the interrupt message, or any combination thereof.

Particular aspects of the disclosure are described below in sets of interrelated Examples:

According to Example 1, a target-side data interface device includes a plurality of upstream ports, each of the plurality of upstream ports assigned to a respective group of data end points (EPs) of a plurality of data EPs and each of the plurality of upstream ports configured to send communications associated with the respective group of data EPs via a respective communication link to a host-side data interface device; a plurality of device controllers, each of the plurality of device controllers configured to be coupled to at least one respective device; and the plurality of data EPs, each of the plurality of data EPs coupled to a respective device controller of the plurality of device controllers, wherein the plurality of data EPs includes a first data EP coupled to a first device controller of the plurality of device controllers, and wherein the first data EP is configured to send, to a first upstream port of the plurality of upstream ports that is assigned to the first data EP, a first input/output (I/O) status message corresponding to an interrupt indicating a first I/O status of a first I/O operation of a first device coupled to the first device controller.

Example 2 includes the target-side data interface device of Example 1, wherein the plurality of data EPs includes a second data EP coupled to a second device controller of the plurality of device controllers, and wherein the second data EP is configured to send, to a second upstream port of the plurality of upstream ports that is assigned to the second data EP, a second I/O status message corresponding to an interrupt indicating a second I/O status of a second I/O operation of a second device coupled to the second device controller.

Example 3 includes the target-side data interface device of Example 1 or Example 2, wherein the first upstream port is configured to be coupled to a first communication link to the host-side data interface device, and wherein the second upstream port is configured to be coupled to a second communication link to the host-side data interface device.

Example 4 includes the target-side data interface device of Example 3, wherein the first communication link is associated with a first data transfer speed that is greater than a second data transfer speed of the second communication link.

Example 5 includes the target-side data interface device of Example 3 or Example 4, wherein the first upstream port is configured to send, based on the first I/O status message, a first interrupt message via the first communication link to the host-side data interface device; and wherein the second upstream port is configured to send, based on the second I/O status message, a second interrupt message via the second communication link to the host-side data interface device.

Example 6 includes the target-side data interface device of any of Examples 2 to 5, wherein a first group of data EPs of the plurality of data EPs is assigned to the first upstream port, wherein a second group of data EPs is assigned to the second upstream port, wherein each of the first group of data EPs is configured to communicate with the host-side data interface device during an active mode of the host-side data interface device and not during an inactive mode of the host-side data interface device, and wherein each of the second group of data EPs is configured to communicate with the host-side data interface device during the active mode of the host-side data interface device, during the inactive mode of the host-side data interface device, or both.

Example 7 includes the target-side data interface device of any of Examples 1 to 6, wherein the target-side data interface device further includes an interrupt EP, and wherein the first upstream port is configured to generate a first interrupt message indicating the first I/O status and an interrupt EP identifier of the interrupt EP to cause an interrupt controller of the host-side data interface device to provide the first I/O status to an interface controller of the host-side data interface device.

Example 8 includes the target-side data interface device of any of Examples 1 to 7, wherein the target-side data interface device further includes a memory configured to store configuration data indicating: for each upstream port of the plurality of upstream ports, an assignment of the upstream port to the respective group of data EPs; and configuration information of the plurality of device controllers; an I/O controller coupled to an I/O EP and configured to receive an interrupt indication from the first device, wherein the interrupt indication includes an interrupt status; and the I/O EP configured to send an interrupt status message to the first upstream port based on a determination that the configuration data indicates that: the first device is coupled to the first device controller, the first device controller is coupled to the first data EP, and the first upstream port is assigned to the first data EP, wherein the interrupt status message indicates the interrupt status, and wherein the first upstream port is configured to send an interrupt message, via a first communication link to the host-side data interface device, that indicates the interrupt status.

Example 9 includes the target-side data interface device of Example 8, wherein the target-side data interface device further includes an interrupt EP, wherein the first upstream port is configured to generate the interrupt message including an interrupt EP identifier of the interrupt EP and an I/O EP identifier of the I/O EP to cause an interrupt controller of the host-side data interface device to provide the interrupt status to an I/O interface associated with the I/O controller.

Example 10 includes the target-side data interface device of any of Examples 1 to 9, wherein the first upstream port is configured to receive a first I/O request via a first communication link from the host-side data interface device; based on a determination that the first I/O request includes a first data EP identifier of the first data EP, provide the first I/O request to the first data EP, wherein the first I/O status message is received from the first data EP responsive to the first I/O request; and subsequent to providing the first I/O request to the first data EP and prior to receiving the first I/O status message from the first data EP: receive a second I/O request via the first communication link from the host-side data interface device; and based on a determination that the second I/O request includes a second data EP identifier of a second data EP, provide the second I/O request to the second data EP.

According to Example 11, a host-side data interface device includes a plurality of downstream ports, each of the plurality of downstream ports assigned to a respective group of data end points (EPs) of a plurality of data EPs, and each of the plurality of downstream ports configured to send communications to the respective group of data EPs via a respective communication link to a target-side data interface device; a plurality of link controllers, each of the plurality of link controllers coupled to a respective downstream port of the plurality of downstream ports; and a plurality of interface controllers, each of the plurality of interface controllers coupled to a respective link controller of the plurality of link controllers, wherein a first interface controller of the plurality of interface controllers is configured to receive a notification of an input/output (I/O) message associated with a data channel, the I/O message addressed to a first device; and based on a determination that the first device is coupled to a first data EP of the plurality of data EPs and that the first data EP is assigned to a first downstream port of the plurality of downstream ports, send an I/O request via a first link controller to the first downstream port.

Example 12 includes the host-side data interface device of Example 11, wherein the I/O message associated with the data channel is from an application being executed at the host-side data interface device.

Example 13 includes the host-side data interface device of Example 11 or Example 12, wherein the interface controller is configured to, based on a determination that a communication protocol of a plurality of communication protocols is associated with the first data EP, generate the I/O request to include a header that includes one or more fields that are associated with the communication protocol, and wherein the header has a pre-determined length that is communication protocol-independent.

Example 14 includes the host-side data interface device of any of Examples 11 to 13 and the host-side data interface device further includes an interrupt controller configured to receive a first interrupt message from the first downstream port, the first interrupt message including an interrupt EP identifier of an interrupt EP and an I/O status, the I/O status corresponding to an interrupt associated with an I/O operation of the first device; and based on a determination that the first interrupt message includes the interrupt EP identifier, provide the I/O status to the interface controller.

Example 15 includes the host-side data interface device of any of Examples 11 to 14 and the host-side data interface device further includes an interrupt controller configured to receive a first interrupt message from the first downstream port, the first interrupt message including a first data EP identifier of the first data EP, an interrupt EP identifier of an interrupt EP, an I/O EP identifier of the I/O EP, and an interrupt status, the interrupt status corresponding to an interrupt associated with the first device; and based on a determination that the first interrupt message includes the interrupt EP identifier and the I/O EP identifier, provide the first data EP identifier and the interrupt status to an I/O interface associated with the I/O EP, wherein the I/O interface is configured to, based on a determination that the first data EP is associated with an application being executed at the host-side data interface device, provide the interrupt status to the application to initiate one or more interrupt handling operations at the application.

Example 16 includes the host-side data interface device of any of Examples 11 to 15 and the host-side data interface device further includes a memory configured to store configuration data indicating, for each downstream port of the plurality of downstream ports, an assignment of the downstream port to the respective group of data EPs.

Example 17 includes the host-side data interface device of Example 16, wherein the first interface controller is configured to send, based on a determination that the configuration data indicates that the first device is coupled to the first data EP and that the first data EP is assigned to the first downstream port, the I/O request via the first link controller to the first downstream port.

According to Example 18, a host-side data interface device includes a downstream port configured to be coupled via a communication link to a target-side data interface device; and an interrupt controller coupled to the downstream port and to an interface controller, the interrupt controller configured to receive an interrupt message from the downstream port, the interrupt message indicating an interrupt end point (EP) identifier of an interrupt EP, a data EP identifier of a data EP, and an input/output (I/O) status, the I/O status corresponding to an interrupt associated with an I/O operation of a first device; and based on a determination that the interrupt message includes the interrupt EP identifier, provide the data EP identifier and the I/O status to the interface controller.

Example 19 includes the host-side data interface device of Example 18, wherein the interface controller is configured to, based on a determination that the I/O status is associated with a transmit data channel: store the I/O status in a memory; and initiate one or more operations at an application being executed at the host-side data interface device.

Example 20 includes the host-side data interface device of Example 18 or Example 19, wherein the interface controller is configured to, based on a determination that the I/O status is associated with a receive data channel that has a pending read operation, send, to the downstream port, a read command addressed to the data EP; receive, responsive to the read command, an interrupt corresponding to a data message from the downstream port, the data message including data from the first device; and responsive to the interrupt, provide the I/O status and the data to an application being executed at the host-side data interface device.

According to Example 18, a method includes receiving, at a data end point (EP) of a plurality of data end points of a target-side data interface device, an interrupt from a device controller of a plurality of device controllers of the target-side data interface device. The interrupt indicates an I/O status of an I/O operation of a first device coupled to the device controller. The method also includes sending, from the data EP to an upstream port of a plurality of upstream ports that is assigned to the data EP, an I/O status message corresponding to the interrupt, where each of the plurality of upstream ports of the target-side data interface device is assigned to a respective group of data end points of the plurality of data points, and where each of the plurality of upstream ports is configured to send communications associated with the respective group of data end points via a respective communication link to a host-side data interface device.

According to Example 19, a method includes receiving, at an interface controller of a host-side data interface (HSDI) device, a notification of an I/O message of a data channel, the I/O message addressed to a first device. The method also includes, based on determining that the first device is coupled to a data end point (EP) of a plurality of data end points of a target-side data interface device, sending an I/O request from the interface controller via a link controller to a downstream port of a plurality of downstream ports that is assigned to the data EP, where each of the plurality of downstream ports is assigned to a respective group of data end points of the plurality of data end points, and where each of the plurality of downstream ports is configured to send communications to the respective group of data end points via a respective communication link to the target-side data interface device.

According to Example 20, a method includes receiving, at an interrupt controller of a host-side data interface device, an interrupt message from a downstream port. The interrupt message indicates an interrupt end point (EP) identifier of an interrupt EP of a target-side data interface device. The interrupt message also indicates an input/output (I/O) status corresponding to an interrupt associated with an I/O operation of a first device. The method also includes, based on a determination that the interrupt message includes the interrupt EP identifier, providing the I/O status to an interface controller of the host-side data interface device.

According to Example 21, an apparatus includes means for receiving, at a data end point (EP) of a plurality of data end points of a target-side data interface device, an interrupt from a device controller of a plurality of device controllers of the target-side data interface device, the interrupt indicating an I/O status of an I/O operation of a first device coupled to the device controller. The apparatus also includes means for sending, from the data EP to an upstream port of a plurality of upstream ports that is assigned to the data EO, an I/O status message corresponding to the interrupt, where each of the plurality of upstream ports of the target-side data interface device is assigned to a respective group of data end points of the plurality of data points, and where each of the plurality of upstream ports is configured to send communications associated with the respective group of data end points via a respective communication link to a host-side data interface device.

According to Example 22, an apparatus includes means for receiving, at an interface controller of a host-side data interface device, a notification of an I/O message of a data channel, the I/O message addressed to a first device. The apparatus also includes means for sending, based on determining that the first device is coupled to a data end point (EP) of a plurality of data end points of a target-side data interface device, an I/O request from the interface controller via a link controller to a downstream port of a plurality of downstream ports that is assigned to the data EP, where each of the plurality of downstream ports is assigned to a respective group of data end points of the plurality of data end points, and where each of the plurality of downstream ports is configured to send communications to the respective group of data end points via a respective communication link to the target-side data interface device.

According to Example 23, an apparatus includes means for receiving, at an interrupt controller of a host-side data interface (HSDI) device, an interrupt message from a downstream port, the interrupt message indicating an interrupt end point (EP) identifier of an interrupt ep of a target-side data interface (TSDI) device. The interrupt message also indicates an input/output (I/O) status corresponding to an interrupt associated with an I/O operation of a first device. The apparatus also includes means for providing, based on a determination that the interrupt message includes the interrupt ep identifier, the I/O status to an interface controller of the HSDI device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A target-side data interface device comprising:
a plurality of upstream ports, each of the plurality of upstream ports assigned to a respective group of data end points (EPs) of a plurality of data EPs and each of the plurality of upstream ports configured to send communications associated with the respective group of data EPs via a respective communication link to a host-side data interface device;
a plurality of device controllers, each of the plurality of device controllers configured to be coupled to at least one respective device; and
the plurality of data EPs, each of the plurality of data EPs coupled to a respective device controller of the plurality of device controllers,
wherein the plurality of data EPs includes a first data EP coupled to a first device controller of the plurality of device controllers, and
wherein the first data EP is configured to send, to a first upstream port of the plurality of upstream ports that is assigned to the first data EP, a first input/output (I/O) status message corresponding to an interrupt indicating a first I/O status of a first I/O operation of a first device coupled to the first device controller.

2. The target-side data interface device of claim 1, wherein the plurality of data EPs includes a second data EP coupled to a second device controller of the plurality of device controllers, and wherein the second data EP is configured to send, to a second upstream port of the plurality of upstream ports that is assigned to the second data EP, a second I/O status message corresponding to an interrupt indicating a second I/O status of a second I/O operation of a second device coupled to the second device controller.

3. The target-side data interface device of claim 2, wherein the first upstream port is configured to be coupled to a first communication link to the host-side data interface device, and wherein the second upstream port is configured to be coupled to a second communication link to the host-side data interface device.

4. The target-side data interface device of claim 3, wherein the first communication link is associated with a first data transfer speed that is greater than a second data transfer speed of the second communication link.

5. The target-side data interface device of claim 3,
wherein the first upstream port is configured to send, based on the first I/O status message, a first interrupt message via the first communication link to the host-side data interface device; and
wherein the second upstream port is configured to send, based on the second I/O status message, a second interrupt message via the second communication link to the host-side data interface device.

6. The target-side data interface device of claim 2, wherein a first group of data EPs of the plurality of data EPs is assigned to the first upstream port, wherein a second group of data EPs is assigned to the second upstream port, wherein each of the first group of data EPs is configured to communicate with the host-side data interface device during an active mode of the host-side data interface device and not during an inactive mode of the host-side data interface device, and wherein each of the second group of data EPs is configured to communicate with the host-side data interface device during the active mode of the host-side data interface device, during the inactive mode of the host-side data interface device, or both.

7. The target-side data interface device of claim 1, further comprising an interrupt EP, wherein the first upstream port is configured to generate a first interrupt message indicating the first I/O status and an interrupt EP identifier of the interrupt EP to cause an interrupt controller of the host-side data interface device to provide the first I/O status to an interface controller of the host-side data interface device.

8. The target-side data interface device of claim 1, further comprising:
a memory configured to store configuration data indicating:
for each upstream port of the plurality of upstream ports, an assignment of the upstream port to the respective group of data EPs; and
configuration information of the plurality of device controllers;
an I/O controller coupled to an I/O EP and configured to receive an interrupt indication from the first device, wherein the interrupt indication includes an interrupt status; and
the I/O EP configured to send an interrupt status message to the first upstream port based on a determination that the configuration data indicates that:
the first device is coupled to the first device controller,
the first device controller is coupled to the first data EP, and
the first upstream port is assigned to the first data EP,
wherein the interrupt status message indicates the interrupt status, and
wherein the first upstream port is configured to send an interrupt message, via a first communication link to the host-side data interface device, that indicates the interrupt status.

9. The target-side data interface device of claim 8, further comprising an interrupt EP, wherein the first upstream port is configured to generate the interrupt message including an interrupt EP identifier of the interrupt EP and an I/O EP identifier of the I/O EP to cause an interrupt controller of the host-side data interface device to provide the interrupt status to an I/O interface associated with the I/O controller.

10. The target-side data interface device of claim 1, wherein the first upstream port is configured to:
receive a first I/O request via a first communication link from the host-side data interface device;
based on a determination that the first I/O request includes a first data EP identifier of the first data EP, provide the first I/O request to the first data EP, wherein the first I/O status message is received from the first data EP responsive to the first I/O request; and
subsequent to providing the first I/O request to the first data EP and prior to receiving the first I/O status message from the first data EP:
receive a second I/O request via the first communication link from the host-side data interface device; and
based on a determination that the second I/O request includes a second data EP identifier of a second data EP, provide the second I/O request to the second data EP.

11. A host-side data interface device comprising:
a plurality of downstream ports, each of the plurality of downstream ports assigned to a respective group of data end points (EPs) of a plurality of data EPs, and each of the plurality of downstream ports configured to send communications to the respective group of data EPs via a respective communication link to a target-side data interface device;
a plurality of link controllers, each of the plurality of link controllers coupled to a respective downstream port of the plurality of downstream ports; and
a plurality of interface controllers, each of the plurality of interface controllers coupled to a respective link controller of the plurality of link controllers,
wherein a first interface controller of the plurality of interface controllers is configured to:
receive a notification of an input/output (I/O) message associated with a data channel, the I/O message addressed to a first device; and
based on a determination that the first device is coupled to a first data EP of the plurality of data EPs and that the first data EP is assigned to a first downstream port of the plurality of downstream ports, send an I/O request via a first link controller to the first downstream port.

12. The host-side data interface device of claim 11, wherein the I/O message associated with the data channel is from an application being executed at the host-side data interface device.

13. The host-side data interface device of claim 11, wherein the interface controller is configured to, based on a determination that a communication protocol of a plurality of communication protocols is associated with the first data EP, generate the I/O request to include a header that includes one or more fields that are associated with the communication protocol, and wherein the header has a pre-determined length that is communication protocol-independent.

14. The host-side data interface device of claim 11, further comprising an interrupt controller configured to:
receive a first interrupt message from the first downstream port, the first interrupt message including an interrupt EP identifier of an interrupt EP and an I/O status, the I/O status corresponding to an interrupt associated with an I/O operation of the first device; and
based on a determination that the first interrupt message includes the interrupt EP identifier, provide the I/O status to the interface controller.

15. The host-side data interface device of claim 11, further comprising an interrupt controller configured to:
receive a first interrupt message from the first downstream port, the first interrupt message including a first data EP identifier of the first data EP, an interrupt EP identifier of an interrupt EP, an I/O EP identifier of the I/O EP, and an interrupt status, the interrupt status corresponding to an interrupt associated with the first device; and
based on a determination that the first interrupt message includes the interrupt EP identifier and the I/O EP identifier, provide the first data EP identifier and the interrupt status to an I/O interface associated with the I/O EP,
wherein the I/O interface is configured to, based on a determination that the first data EP is associated with an application being executed at the host-side data interface device, provide the interrupt status to the application to initiate one or more interrupt handling operations at the application.

16. The host-side data interface device of claim 11, further comprising a memory configured to store configuration data indicating, for each downstream port of the plurality of downstream ports, an assignment of the downstream port to the respective group of data EPs.

17. The host-side data interface device of claim 16, wherein the first interface controller is configured to send, based on a determination that the configuration data indicates that the first device is coupled to the first data EP and that the first data EP is assigned to the first downstream port, the I/O request via the first link controller to the first downstream port.

18. A host-side data interface device comprising:
a downstream port configured to be coupled via a communication link to a target-side data interface device; and
an interrupt controller coupled to the downstream port and to an interface controller, the interrupt controller configured to:
receive an interrupt message from the downstream port, the interrupt message indicating an interrupt end point (EP) identifier of an interrupt EP, a data EP identifier of a data EP, and an input/output (I/O) status, the I/O status corresponding to an interrupt associated with an I/O operation of a first device; and
based on a determination that the interrupt message includes the interrupt EP identifier, provide the data EP identifier and the I/O status to the interface controller.

19. The host-side data interface device of claim 18, wherein the interface controller is configured to, based on a determination that the I/O status is associated with a transmit data channel:
store the I/O status in a memory; and
initiate one or more operations at an application being executed at the host-side data interface device.

20. The host-side data interface device of claim 18, wherein the interface controller is configured to:
based on a determination that the I/O status is associated with a receive data channel that has a pending read operation, send, to the downstream port, a read command addressed to the data EP;
receive, responsive to the read command, an interrupt corresponding to a data message from the downstream port, the data message including data from the first device; and
responsive to the interrupt, provide the I/O status and the data to an application being executed at the host-side data interface device.
